(19) United States
(12) Patent Application Publication
(10) Pub. No.: US 2026/0250194 A1
(43) Pub. Date: Aug. 27, 2026

(54) HEAVY-METAL-REDUCED POST-INDUSTRIAL WASTE IN CEMENTITIOUS MATERIALS AND METHODS OF MAKING AND USING THEREOF

(71) Applicant: William Marsh Rice University, Houston, TX (US)

(72) Inventors: James M. TOUR, Houston, TX (US); Bing DENG, Houston, TX (US); Satish NAGARAJAIAH, Houston, TX (US); Wei MENG, Houston, TX (US)

(73) Assignee: WILLIAM MARSH RICE UNIVERSITY, Houston, TX (US)

(21) Appl. No.: 18/853,990

(22) PCT Filed: Apr. 7, 2023
(86) PCT No.: PCT/US2023/065506

§ 371 Date: Oct. 3, 2024

Related U.S. Application Data
(60) Provisional application No. 63/328,630, filed on Apr. 7, 2022.

(51) Int. Cl. C04B 18/08; C04B 18/04; C04B 18/12; C04B 18/14; C04B 22/02; C04B 28/04; C04B 111/94

(52) U.S. Cl. CPC C04B 18/081; C04B 18/0409; C04B 18/12; C04B 18/141; C04B 18/146; C04B 22/02; C04B 28/04; C04B 2111/94

(57) ABSTRACT

Ultrafast flash Joule heating methods and systems, and more particularly, methods and systems for removing heavy metals from post-industrial waste, such as coal fly ash or bauxite residue. The use of the purified post-industrial waste includes forming cementitious materials that include the purified post-industrial waste and cement.

### CROSS-REFERENCED TO RELATED PATENT APPLICATIONS

The application claims priority to U.S. Patent Appl. Ser. No. 63/328,630, filed Apr. 7, 2022, entitled “Removal Of Heavy Metals From Waste And Uses Thereof,” which Patent application is commonly owned by the owner of the present invention. This patent application is incorporated herein in its entirety.

### STATEMENT REGARDING FEDERALLY SPONSORED RESEARCH

This invention was made with government support under Grant No. FA9550-22-1-0526, awarded by the United States Air Force Office of Scientific Research, and Grant No. W912HZ-21-2-0050, awarded by the U.S. Army Corps of Engineers. The government has certain rights in the invention.

### TECHNICAL FIELD

The present invention relates to ultrafast flash Joule heating methods and systems, and more particularly, methods and systems for removing heavy metals from post-industrial waste (such as coal fly ash or bauxite residue) and uses of the purified post-industrial waste in cementitious materials.

### BACKGROUND

The growing global demand for materials continuously increases greenhouse gas (GHG) emissions. [Daehn 2022]. Building materials are the third-largest source of anthropogenic carbon dioxide (CO₂) emission. [Andrew 2019]. For example, global CO₂ emissions of cement production are ~1.5 Gt annually, representing ~8% of the total global GHG emissions. [Andrew 2019; Olivier 2016]. Hence, the cement industry is an important sector for GHG emission mitigation strategies [Zhong 2021], and there is renewed interest in alternative raw materials [Miller 2020] with lower production emissions to replace or partially substitute the highest volume building material, ordinary Portland cement (OPC).

Among the alternative cementitious materials [Miller 2020], coal fly ash (CFA) has been extensively investigated and utilized worldwide. [Yao 2015]. CFA is the predominantly inorganic residue of coal combustion in power plant furnaces, with an annual worldwide production of ~750 million tons. [Blissett 2012; Sahoo 2016]. CFA is primarily silicon (Si), aluminum (Al), iron (Fe), and calcium (Ca) oxides while containing smaller amounts of heavy metals, such as cadmium (Cd), cobalt (Co), copper (Cu), nickel (Ni), lead (Pb), and mercury (Hg). [Fernández-Turiel 1994; Koukouzas 2011].

Hence, CFA is classified as hazardous waste in some countries if the toxic substances exceed limits; other countries regulate it as non-hazardous with special regulations. [EPA 2015]. The improper disposal of CFA has become an environmental concern because of potential water, soil, and air pollution. [Yao 2015; Yao 2014]. As a result, reuse, rather than disposal or landfilling, of CFA is sought for both economic and environmental reasons. [Andrew 2019; Blissett 2012].

CFA with high calcium content has considerable cementitious properties [ASTM C618-08 2008], making it useful for OPC dilution. [Rafieizonooz 2016; Canpolat 2004]. However, the leachability of heavy metals from CFA [Wang N 2020; Praharaj 2002], when it is in contact with aqueous environments such as rainwater, has impeded its applications in cement. [Yu 2005; Ma 2019]. Therefore, removal of toxic elements from CFA is necessary prior to landfilling or secondary use.

The prior art methods for heavy metal removal mostly rely on acid washing process, including the use of inorganic acids [Kashiwakura 2010] or organic acids [Ishaq 2013], both of which suffer from the consumption of chemicals and generation of large wastewater streams that reduce the value of economic incentives and result in secondary pollution. [Praharaj 2002; Kashiwakura 2010].

Thus, development of cementitious materials with low carbon footprint is critical for greenhouse gas mitigation. And, while coal fly ash (CFA) is an attractive diluent additive in cement due to its widespread availability and ultralow cost, the heavy metals in CFA could leach out over time. Moreover, traditional acid washing processes for heavy metal removal suffer from high chemical consumption and high-volume wastewater streams.

Accordingly, the need remains for improved methods and systems for removing heavy metals from post-industrial waste (such as coal fly ash and bauxite residue) yields a waste product with reduced heavy metals for use in cementitious material.

### SUMMARY OF THE INVENTION

The present invention relates to ultrafast flash Joule heating methods and systems, and more particularly, methods and systems for removing heavy metals from post-industrial waste (such as coal fly ash or bauxite residue) and uses of the purified post-industrial waste in cementitious materials.

In general, in one embodiment, the invention features a method of forming a cementitious material. The method includes forming a mixture including post-industrial waste and a conductive additive. The method further includes applying a voltage across the mixture. The voltage is applied in one or more voltage pulses. The duration of each of the one or more voltage pulses is for a duration period. The applying of the voltage removes at least 50% by weight of the heavy metals from the post-industrial waste to form a purified post-industrial waste. The method further includes mixing the purified post-industrial waste with cement to form a cementitious material.

Implementations of the invention can include one or more of the following features:

The post-industrial waste can be fly ash.

The fly ash can be coal fly ash.

The coal fly ash can be C coal fly ash.

The coal fly ash can be F coal fly ash.

The post-industrial waste can be bauxite residue.

The post-industrial waste can be slag.

The slag can be selected from the group consisting of boiler slag, furnace slag, tap slag, raker slag, synthetic slag, ladle slag, pit slag, cleanout slag, riverbed slag, and combinations thereof.

The post-industrial waste can be mining tailings.

The post-industrial waste can be silica fume.

The duration of each of the one or more voltage pulses can be between 1 microsecond and 5 seconds.

The conductive additive can be a carbon source.

The carbon source can be selected from a group consisting of carbon black, graphene, flash graphene, coal, anthracite, coke, metallurgical coke, calcined coke, activated charcoal, biochar, natural gas carbon that had been stripped of its hydrogen atoms, furnace black, activated charcoal, shungite, plastic waste, plastic waste-derived carbon char, food waste, food waste-derived carbon char, biomass, biomass-derived carbon char, hydrocarbon gas, and mixtures therefrom.

The carbon source can be carbon black.

The carbon source can be metallurgical coke.

The carbon source can be plastic pyrolysis ash.

The conductive source can include metal flakes.

The metal flakes can be aluminum flakes.

The step of forming the mixture can include adding the conductive additive to the post-industrial waste.

The post-industrial waste can include the conductive additive.

The mixture can have a resistivity that is at most 50Ω.

The resistivity of the mixture can be between 0.5Ω and 5Ω.

The resistivity of the mixture can be between 1Ω and 3Ω.

The applying of the voltage can remove at least 70% by weight of the heavy metals from the post-industrial waste to form a purified post-industrial waste.

At least 50% by weight of the heavy metals can be removed from the post-industrial waste during the application of the first voltage pulse of the one or more voltage pulses.

At least 70% by weight of the heavy metals can be removed from the post-industrial waste during the application of the first voltage pulse of the one or more voltage pulses.

The heavy metals can include one or more metals selected from the group consisting of Al, As, Ba, Be, Bi, B, Ca, Cd, Cs, Cr, Co, Cu, Ga, In, Fe, Pb, Li, Mg, Mn, Ni, P, K, Rb, Se, Si, Ag, Na, Sr, S, Te, TI, V, Zn, and combinations thereof.

The heavy metals can be one or more metals selected from the group consisting of As, Cd, Co, Ni, Pb, and combinations thereof.

The method can further include removing residual carbon from the post-industrial waste after the step of applying the voltage across the mixture.

The step of removing the residual carbon can include calcination.

The step of calcination can be performed in air at a temperature of at least 600° C. for at least 30 minutes.

The step of calcination can be performed in air at a temperature of at least 700° C. for at least one hour.

The step of removing the residual carbon can include a physical separation step.

The physical separation step can include sieving the post-industrial waste after the step of applying the voltage across the mixture.

The purified post-industrial waste can be mixed with the cement in a weight ratio between about 1:9 and about 1:1.

The purified post-industrial waste can be mixed with the cement in a weight ratio between about 1:4 and about 2:3.

The purified post-industrial waste can be mixed with the cement in a weight ratio of about 3:7.

The method can be a water-free process.

The method can be not including an acid wash step.

In general, in another embodiment, the invention features a cementitious material. The cementitious material includes a purified post-industrial waste. The purified post-industrial waste has at least 50% by weight less heavy metals as compared to post-industrial waste before purification. The cementitious material further includes cement.

Implementations of the invention can include one or more of the following features:

The purified post-industrial waste can have at least 70% by weight less heavy metals as compared to post-industrial waste before purification.

The purified-post industrial waste can be made by the process that can include forming a mixture including the post-industrial waste and a conductive additive. The conductive additive can be a carbon source. The process can further include applying a voltage across the mixture. The voltage can be applied in one or more voltage pulses. The duration of each of the one or more voltage pulses can be for a duration period. The applying of the voltage can remove at least 50% by weight of the heavy metals from the post-industrial waste to form the purified post-industrial waste.

The applying of the voltage can remove at least 70% by weight of the heavy metals from the post-industrial waste to form the purified post-industrial waste.

The cementitious material can be made by the method of any of the above-described methods for forming a cementitious material.

The method for making the cementitious material can be a water-free process.

The method for making the cementitious material can be not including an acid wash step.

The post-industrial waste can be fly ash.

The fly ash can be coal fly ash.

The coal fly ash can be C coal fly ash.

The coal fly ash can be F coal fly ash.

The post-industrial waste can be bauxite residue.

The post-industrial waste can be slag.

The slag can be selected from the group consisting of boiler slag, furnace slag, tap slag, raker slag, synthetic slag, ladle slag, pit slag, cleanout slag, riverbed slag, and combinations thereof.

The post-industrial waste can be mining tailings.

The post-industrial waste can be silica fume.

The cementitious material can include the purified post-industrial waste and the cement in a weight ratio between about 1:9 and about 1:1.

The cementitious material can be the purified post-industrial waste and the cement in a weight ratio between about 1:4 and about 2:3.

The cementitious material can include the purified post-industrial waste and the cement in a weight ratio of about 3:7.

In general, in another embodiment, the invention features a system for forming a cementitious material. The system includes a source of a mixture including post-industrial waste and a conductive additive. The system further includes a cell operably connected to the source such that the mixture can be flowed into the cell and held under compression. The system further includes electrodes operatively connected to pressure cell. The system further includes a flash power supply for applying a voltage across the mixture. The voltage is applied in one or more voltage pulses. The duration of each of the one or more voltage pulses is for a duration period. The applying of the voltage removes at least 50% by weight of the heavy metals from the post-industrial waste to form a purified post-industrial waste. The system further includes a collector operatively connected to the cell to collect the purified post-industrial waste. The system further includes a mixer operable for mixing the collected purified post-industrial waste with cement to form the cementitious material.

Implementations of the invention can include one or more of the following features:

The system can perform the method of forming a cementitious material utilizing any of the above-described methods for forming a cementitious material.

The method for making the cementitious material can be a water-free process.

The method for making the cementitious material can be not including an acid wash step.

The cementitious material is any of the cementitious materials of the above-described cementitious materials.

The post-industrial waste can be fly ash.

The fly ash can be coal fly ash.

The coal fly ash can be C coal fly ash.

The coal fly ash can be F coal fly ash.

The post-industrial waste can be bauxite residue.

The post-industrial waste can be slag.

The slag can be selected from the group consisting of boiler slag, furnace slag, tap slag, raker slag, synthetic slag, ladle slag, pit slag, cleanout slag, riverbed slag, and combinations thereof.

The post-industrial waste can be mining tailings.

The post-industrial waste can be silica fume.

The duration of each of the one or more voltage pulses can be between 1 microsecond and 5 seconds.

The conductive additive can be a carbon source.

The carbon source can be selected from a group consisting of carbon black, graphene, flash graphene, coal, anthracite, coke, metallurgical coke, calcined coke, activated charcoal, biochar, natural gas carbon that had been stripped of its hydrogen atoms, furnace black, activated charcoal, shungite, plastic waste, plastic waste-derived carbon char, food waste, food waste-derived carbon char, biomass, biomass-derived carbon char, hydrocarbon gas, and mixtures therefrom.

The carbon source can be carbon black.

The carbon source can be metallurgical coke.

The carbon source can be plastic pyrolysis ash.

The conductive source can include metal flakes.

The metal flakes can be aluminum flakes.

The step of forming the mixture can include adding the conductive additive to the post-industrial waste.

The post-industrial waste can include the conductive additive.

The mixture can have a resistivity that is at most 50Ω.

The resistivity of the mixture can be between 0.5Ω and 5Ω.

The resistivity of the mixture can be between 1Ω and 3Ω.

The applying of the voltage can remove at least 70% by weight of the heavy metals from the post-industrial waste to form a purified post-industrial waste.

At least 50% by weight of the heavy metals can be removed from the post-industrial waste during the application of the first voltage pulse of the one or more voltage pulses.

At least 70% by weight of the heavy metals can be removed from the post-industrial waste during the application of the first voltage pulse of the one or more voltage pulses.

The heavy metals can include one or more metals selected from the group consisting of Al, As, Ba, Be, Bi, B, Ca, Cd, Cs, Cr, Co, Cu, Ga, In, Fe, Pb, Li, Mg, Mn, Ni, P, K, Rb, Se, Si, Ag, Na, Sr, S, Te, TI, V, Zn, and combinations thereof.

The heavy metals can be one or more metals selected from the group consisting of As, Cd, Co, Ni, Pb, and combinations thereof.

The system can further include a separator for removing residual carbon from the post-industrial waste after the step of applying the voltage across the mixture.

The separator can include a calciner for calcination of the post-industrial waste after the step of applying the voltage across the mixture.

The calciner can be operable for performing calcination in air at a temperature of at least 600° C. for at least 30 minutes.

The calciner can be operable for performing calcination in air at a temperature of at least 700° C. for at least one hour.

The separator can be a physical separator.

The physical separator can include a sieve.

The cementitious cement can include the purified post-industrial waste and the cement in a weight ratio between about 1:9 and about 1:1.

The cementitious cement can include the purified post-industrial waste and the cement in a weight ratio between about 1:4 and about 2:3.

The cementitious cement can include the purified post-industrial waste and the cement in a weight ratio of about 3:7.

### BRIEF DESCRIPTION OF THE DRAWINGS

FIGS. 1A-1F show characterization of coal-fly ash (CFA). FIG. 1A is XRD patterns of class C coal fly ash (CFA-C) and class F coal fly ash (CFA-F). Mullite (PDF 15-0776) and quartz (PDF 33-1161) are used as references. FIG. 1B is XPS full spectra of CFA-C and CFA-F. FIGS. 1C-1D are SEM images of, respectively, CFA-C and CFA-F. FIG. 1E shows heavy metal content in CFA-C (with inset of a picture of CFA-C). FIG. 1F shows heavy metal content in CFA-F (with inset of a picture of CFA-F). The error bars in FIGS. 1E-1F denote the standard deviation where n=3.

FIGS. 2A-2F show removal of heavy metals in coal fly ash (CFA) by flash Joule heating (FJH). FIG. 2A is a schematic of the FJH process to removal heavy metals in CFA. CB, carbon black. FIG. 2B is a current curve with FJH voltage of 120 V for 1 s. FIG. 2C is a realtime temperature curve with FJH voltage of 120 V for 1 s. FIG. 2D shows vapor pressure-temperature relationship of representative heavy metals and carbon. (The vapor pressure values are from CRC Handbook of Chemistry and Physics [Lide 2005]). FIG. 2E shows removal efficiencies of heavy metals from class F coal fly ash (CFA-F) vs the FJH voltage. FIG. 2F shows single FJH removal efficiencies of heavy metals from CFA-F at the FJH voltage of 120 V. The error bars FIGS. 2E-2F denote the standard deviation where n=3.

FIG. 3 shows heavy metal contents in carbon black. The error bars denote the standard deviation where n=3.

FIGS. 4A-4B show removal of heavy metals from class C coal fly ash (CFA-C). FIG. 4A shows removal efficiencies of heavy metals from CFA-C varied with the flash Joule heating (FJH) voltage. FIG. 4B shows removal efficiencies of heavy metals from CFA-C at a FJH voltage of 120 V. The error bars in FIGS. 4A-4B denote the standard deviation where n=3.

FIGS. 5A-5D show improving the heavy metals removal efficiency of CFA-C by multiple flash Joule heating (FJH) pulses. FIGS. 5A-5D show, respectively, Cd, Co, Ni, and Pb removal efficiencies varied with FJH pulses. The error bars denote the standard deviation where n=3.

FIGS. 6A-6B show effect of chemical state to the FJH process. FIG. 6A shows thermodynamic analysis of carbothermic reduction of PbO and thermal decomposition of PbSO₄. FIG. 6B shows vapor pressure-temperature relationships of Pb species.

FIG. 7 shows sample resistance measurement with sample resistance varied with mass ratio of coal fly ash (CFA) and carbon black (CB).

FIGS. 8A-8B show removal of heavy metals from CFA-F using metallurgical coke (metcoke) as the conductive additive. FIG. 8A shows heavy metal content in metcoke. FIG. 8B shows removal efficiencies of heavy metals from CFA-F with a single flash Joule heating (FJH) voltage of 120 V and 1 s. The error bars denote the standard deviation where n=3.

FIGS. 9A-9B show removal of heavy metals from CFA-F using Plastic Ash as the conductive additive. FIG. 9A shows heavy metal content in Plastic Ash. FIG. 9B shows heavy metal removal efficiencies of from CFA-F with flash Joule heating (FJH) voltage of 120 V and 1 s. The error bars denote the standard deviation where n=3.

FIG. 10A-10F show separation and reuse of the carbon additives. FIG. 10A is a picture of the mixture of coal fly ash (CFA) and metallurgical coke (metcoke). FIG. 10B is a picture of the mixture of CFA and metcoke after flash Joule heating (FJH). FIG. 10C shows the separation of CFA and metcoke by sieving. FIG. 10D is a picture of the separated CFA and recovered metcoke. FIG. 10E is a picture of the mixture of CFA and recovered metcoke after FJH. FIG. 10F is a picture of the separated CFA and recovered metcoke.

FIG. 11 shows residual carbon in the CFA sample after sieving separation (TGA curve of purified CFA after CB removal by sieving). TGA was conducted in air with the heating rate of 10° C./min.

FIGS. 12A-12B show characterization of coal fly ash (CFA) after flash Joule heating (FJH). FIG. 12A is XRD patterns of class F coal fly ash (CFA-F) raw material and CFA-F after FJH. FIG. 12B is XRD patterns of class C coal fly ash (CFA-C) raw material and CFA-C after FJH. Mullite (PDF 15-0776) and quartz (PDF 33-1161) are used as references.

FIGS. 13A-13B show XRF characterization of coal fly ash (CFA). FIG. 13A shows main inorganic component molar percentage of class C CFA raw material (CFA-C-Raw), CFA-C after flash Joule heating (CFA-C-FJH), and CFA-C after FJH and calcination (CFA-C-FJH-Calcination). FIG. 13B shows main inorganic component molar percentage of class F CFA raw materials (CFA-F-Raw), CFA-F after FJH (CFA-F-FJH), and CFA-F after FJH and calcination (CFA-F-FJH-Calcination). The calcination was conducted in air at 700° C. for 1 h to remove the residual carbon.

FIG. 14 shows element characterization of coal fly ash (CFA) (XPS full spectra of class F CFA from Boral Cumberland (CFA-F-BC), and class C CFA from Charah White Bluff (CFA-C-CWB)).

FIG. 15A-15B shows characterization of coal fly ash (CFA) after flash Joule heating (FJH). FIG. 15A is XRD patterns of class C CFA from Charah White Bluff (CFA-C-CWB) raw materials and CFA-C-CWB after FJH. FIG. 15B is XRD patterns of class F CFA from Boral Cumberland (CFA-F-BC) raw material and CFA-F-BC after FJH. Mullite (PDF 15-0776) and quartz (PDF 33-1161) are used as references.

FIGS. 16A-16D show generality of the flash Joule heating (FJH) process for heavy metal removal. FIG. 16A shows heavy metal content in class C coal fly ash collected from Charah White Bluff (CFA-C-CWB) and the removal efficiencies by FJH at 120 V for 1 s. FIG. 16B shows heavy metal content in class F coal fly ash collected from Boral Cumberland (CFA-F-BC) and the removal efficiencies by FJH at 120 V for 1 s. FIG. 16C is XRD pattern of bauxite residue (BR) (with inset of a picture of BR and hematite (PDF 02-0919) and calcite (PDF 47-1743) used as references). FIG. 16D shows heavy metal content in BR raw materials and the BR after a single FJH process. The error bars in FIGS. 16A-16B and FIG. 16D denote the standard deviation where n=3.

FIG. 17 shows characterization of BR after FJH (XRD patterns of bauxite residue (BR) raw materials and BR after flash Joule heating (FJH)). Hematite (PDF 02-0919) and calcite (PDF 47-1743) are used as references.

FIGS. 18A-18F show application of purified class C coal fly ash (CFA-C) in cement composites. FIG. 18A is TGA curve of CFA-C raw materials and the mixture of CFA-C and carbon black (CB) after flash Joule heating (FJH) (with inset of a picture of the mixture of CFA-C and residual carbon, and the purified CFA-C after calcination in air at 700° C. for 1 h).

FIG. 18B is stress-strain curves of the pure ordinary Portland cement (Pure OPC), the OPC substituted with 30 wt % raw CFA-C(OPC/raw CFA), and the OPC substituted with 30 wt % purified CFA-C(OPC/purified CF) (with inset of a picture of a cement sample for mechanical properties measurement. FIG. 18C shows compressive strengths and moduli of elasticity statistics of the Pure OPC, OPC/raw CFA, and OPC/purified CFA. The error bars denote the standard deviation where n=3. FIGS. 18D-18F show accumulated heavy metals content leached from the raw CFA cement, purified CFA cement, and OPC cement for, respectively As, Co, and Ni.

FIGS. 19A-19D show SEM characterization of class C coal fly ash (CFA-C). FIG. 19A is an SEM image of CFA-C Raw materials. FIG. 19B is an SEM image of the mixture of CFA-C and CB (CFA-C-CB). FIG. 19C is an SEM image of the CFA-C-CB after FJH (CFA-C-CB-FJH). FIG. 19D is an SEM image of the CFA-C-CB after FJH and calcination (CFA-C-CB-FJH-Calcination). The calcination was conducted in air at 700° C. for 1 h to remove the carbon residue.

FIGS. 20A-20B show measurement of purified coal fly ash (CFA) in cement composites after 1-day curing. FIG. 20A is representative stress-strain curves of the pure ordinary Portland cement (Pure OPC), the OPC substituted with 30 wt % raw CFA (OPC/raw CFA), and the OPC substituted with 30 wt % purified CFA (OPC/purified CFA). FIG. 20B is compressive strengths and moduli of elasticity statistics of the Pure OPC, the OPC/raw CFA, and the OPC/purified CFA. The error bars denote the standard deviation where n=3.

FIG. 21 shows application of purified class C coal fly ash (CFA-C) with carbon residue in cement (stress-strain curves of the ordinary Portland cement (OPC) substituted with 5 wt % CFA-C raw materials (OPC/raw CFA-C), and the OPC substituted with 5 wt % purified CFA-C with residual carbon black (OPC/purified CFA-C/CB)). Two independent experiments were conducted for the two different kinds of samples.

FIG. 22 shows application of purified class F coal fly ash (CFA-F) in cement (stress-strain curves of the pure ordinary Portland cement (pure OPC), the OPC substituted with 30 wt % raw CFA-F (OPC/raw CFA-F), and the OPC substituted with 30 wt % purified CFA-F after removing the residual carbon by calcination (OPC/purified CFA-F)).

FIGS. 23A-23C shows scaling up of the FJH process. FIG. 23A is a picture of the FJH setup with total capacitance of 0.624 F. FIG. 23B is a FJH reaction stage. FIG. 23C is a FJH sample size of 3 g per batch.

FIG. 24 shows a design of a continuous FJH reactor.

FIGS. 25A-25D show Flow chart representations and boundary conditions of the life cycle analysis (LCA) models. FIG. 25A shows a flow chart representation and boundary conditions for the LCA scenario of Landfilling. FIG. 25B shows a flow chart representation and boundary conditions for the LCA scenario of Direct Substitution. CFA, coal fly ash. FIG. 25C shows a flow chart representation and boundary conditions for the LCA scenario of FJH-Separation-Substitution. FIG. 25B shows a flow chart representation and boundary conditions for the LCA scenario of FJH-Substitution.

FIGS. 26A-26C show LCA for the reuse of coal fly ash (CFA) in cement. FIG. 26A shows a comparison of heavy metal emissions. FIG. 26B shows a comparison of greenhouse gas (GHG) emissions. FIG. 26C shows a comparison of energy consumptions.

FIGS. 27A-27C show environmental impact assessment. FIG. 27A shows heavy metal emission percentage of various scenarios normalized to Landfilling. FIG. 27B shows greenhouse gas (GHG) emission percentage of various scenarios normalized to Landfilling.

FIG. 27C shows energy consumption percentage of various scenarios normalized to Landfilling.

FIGS. 28A-28D show comparison of the flash Joule heating (FJH) method with existing methods for heavy metal removal from CFA. FIG. 28A shows water consumption per ton of CFA. FIG. 28B shows materials cost per ton of CFA. FIG. 28C shows time consumption. FIG. 28D shows removal efficiencies.

### DETAILED DESCRIPTION

The present invention relates to ultrafast flash Joule heating methods and systems, and more particularly, methods and systems for removing heavy metals from post-industrial waste (such as coal fly ash or bauxite residue) and uses of the purified post-industrial waste in cementitious materials.

Recently, highly efficient, short-burst electric heating is emerging as a high temperature technology for materials production [Liu S 2022; Liu C 2022; Liu S 2020; Wang C 2020; Cheng 2022; Chen I 2016; Yao 2018] and solid waste management [Barbhuiya 2021]. Chen I 2016 first reported the rapid Joule heating for ultrafast synthesis of nanoparticles in reduced graphene oxide films. The carbothermic shock was then widely applied for various nanomaterials syntheses [Jiang 2021], including silicon nanoparticles [Chen II 2016], high-entropy alloy nanoparticles [Yao 2018], and single-atom catalysts [Yao 2019]. The FJH process has been used to convert carbon-containing sources into flash graphene [Luong 2020]. In addition to the functional materials synthesis capability [Deng I 2022; Chen 2021], the FJH process has been demonstrated to be an efficient method for sustainable management of carbon-rich wastes, such as consumer plastic [Algozeeb 2020; Wyss 2021], and rubber [Advincula 2021]. With the ultrahigh temperature reaching ≥3000° C. and ultrafast process lasting ≤1 s, the FJH method enables the evaporative separation of precious metals from electronic wastes for urban mining [Deng 2021], the activation of industrial wastes for high-yield rare earth elements recovery [Deng II 2022], the recycling of photovoltaic silicon waste [Lu 2021], and recovery of lithium-ion batteries graphite anodes and cathodes [Cui 2021].

It has been discovered that a water-free process based on FJH can be utilized to remove heavy metals rapidly and efficiently from CFA, and such heavy metal removed CFA has great utilizing, including in cementitious material. This means that no acid wash is required, thereby eliminating any secondary aqueous waste stream.

In embodiments, the FJH process ramps the temperature to ~3000° C. within 1 s, enabling the evaporative removal of various heavy metals from CFA with efficiencies of 70-90% for As, Cd, Co, Ni, and Pb within a single FJH treatment. The removal efficiencies are further increased by repeating the 1 s FJH pulse. The FJH method works for CFA regardless of the types (class F and class C) and the geographical origins.

While the disclosure below is directed primarily to CFA, a similar FJH strategy can also be applied to the purification of other post-industrial wastes, such as large-scale bauxite residue (red mud) further showing the generality of the process for solid wastes decontamination and valorization. “Post-industrial waste” refers to materials that are from the waste stream in a manufacturing process, such a coal fly ash, bauxite residue (also referred to in slurry form as “red mud”), slag (such as boiler slag, furnace slag, tap slag, raker slag, synthetic slag, ladle slag, pit slag, cleanout slag, and riverbed slag), mining tailings, and silica fume.

### Heavy Metals in CFA

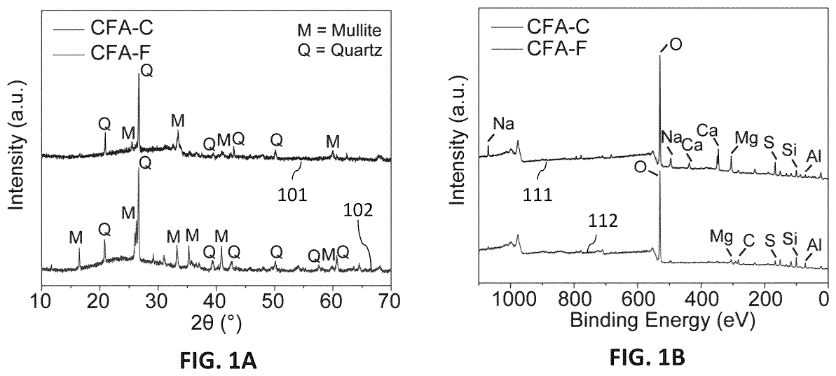

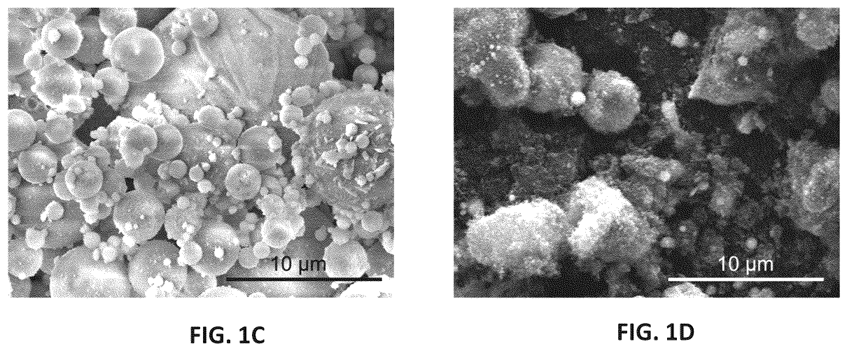

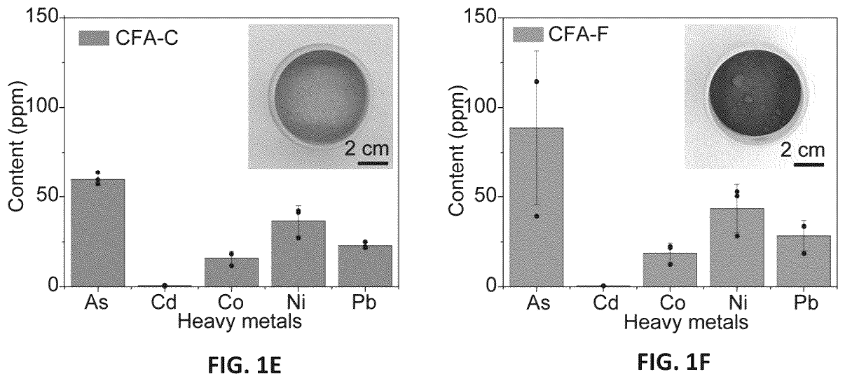

Based on chemical composition, CFA is categorized into class F CFA (CFA-F) and class C CFA (CFA-C). While both contain major components of SiO₂, Al₂O₃, and Fe₂O₃, CFA-C has a high abundance of CaO [Liu P 2019]. CFA-F was collected for analysis from the Appalachian Basin (App) and CFA-C was collected for analysis from Powder River Basin (PRB), both in the United States. While CFA is mostly composed of glassy phases produced during the coal burning process⁵⁰ [Zhang 2020], the crystalline components mainly include quartz (SiO₂) and mullite (aluminum silicate, 3Al₂O₃·2SiO₂), according to X-ray diffraction (XRD) analyses. See FIG. 1A (with plots 101-102 for CFA-C and CFA-F, respectively).

In addition to the Ca enrichment in CFA-C, elemental analysis by X-ray photoelectron spectroscopy (XPS) also shows an abundance of carbon in CFA-F (FIG. 1B with plots 111-122 for CFA-C and CFA-F, respectively), which might be from the incomplete combustion of coal. The morphology of the CFA was characterized by scanning electron microscopy (SEM). The particle size of CFA-C was ~1-10 μm (FIG. 1C), while the CFA-F was ~1-8 μm (FIG. 1D).

To assess the CFA samples, they were digested by acid. A mixed standard was used (Millipore-Sigma, periodic table mix 1 for ICP; 33 elements; 10 mg L⁻¹ each; Al, As, Ba, Be, Bi, B, Ca, Cd, Cs, Cr, Co, Cu, Ga, In, Fe, Pb, Li, Mg, Mn, Ni, P, K, Rb, Se, Si, Ag, Na, Sr, S, Te, Tl, V and Zn in 10% HNO₃ containing a trace of HF). HNO₃ (67-70 wt %, TraceMetal™ Grade, Fisher Chemical), HCl (37 wt %, 99.99% trace metals basis, Millipore-Sigma), H₂O₂ (30 wt %, for trace analysis, Millipore-Sigma), and ultrapure water (Millipore-Sigma, ACS reagent for ultratrace analysis) were used for sample digestion. The samples were digested using the method modified from a standard from the Environmental Protection Agency (EPA), USA. [EPA 1996].

Generally, ~50 mg samples were added into 2 mL HNO₃ (67-70%, 1:1 v:v with water) at 95° C. for 2 h. Then, 2 mL H₂O₂ (30 wt %, 1:1 v:v with water) were added and heated to reflux (95° C.) for 2 h. Then, 1 mL HCl (37 wt %) and 5 mL H₂O were added and heated to reflux for 15 min. The acidic solution was then filtered to remove any undissolved solid particles using a sand core funnel (Class F). The obtained solution was diluted to the range within the calibration curve, which is between 1 part per billion (ppb) to 1000 ppb.

The trace heavy metal contents were measured by inductively coupled plasma mass spectrometry (ICP-MS). It is found that the As, Cd, Co, Ni, and Pb exist in the CFA, with As, 59.7±3.3 ppm; Cd, 0.76±0.36 ppm; Co, 15.9±3.8 ppm; Ni, 36.6±8.4 ppm; and Pb, 22.8±1.7 ppm for CFA-C (FIG. 1E); and As, 88.6±43.0 ppm; Cd, 0.62±0.08 ppm; Co, 18.7±5.5 ppm; Ni, 43.5±13.5 ppm; and Pb, 28.3±8.6 ppm for CFA-F (FIG. 1F). It was intriguing that the heavy metal content in the CFA-F and CFA-C samples were similar even though they were different types and were from different geological origins.

### Removal of Heavy Metals in CFA by FJH

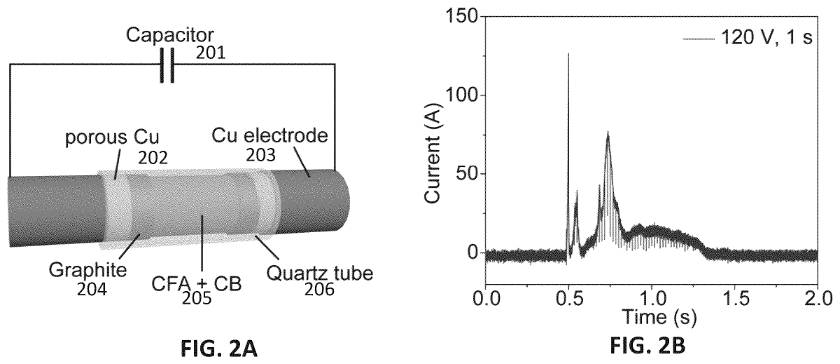

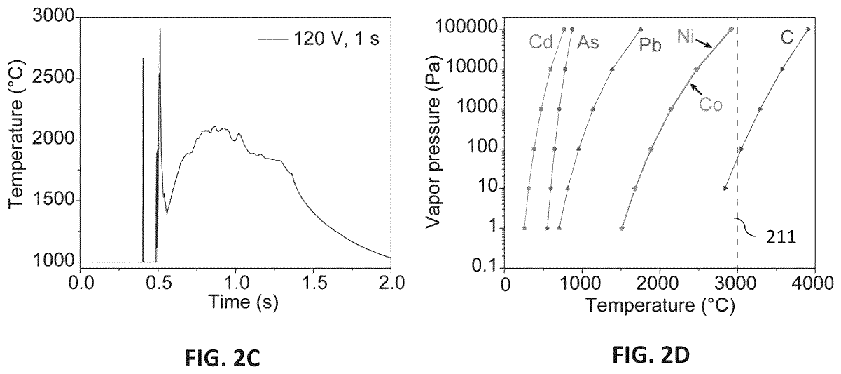

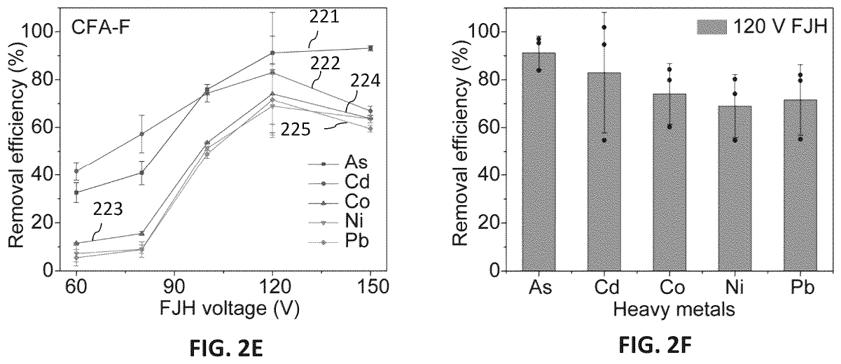

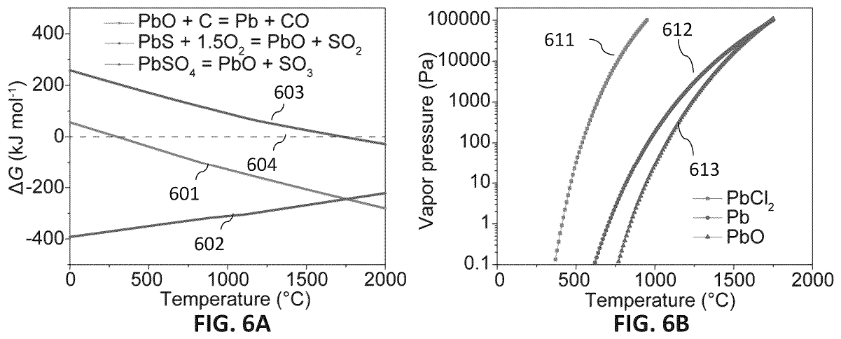

For the analyses, generally, the CFA was mixed with carbon black (CB), ~30 wt %, which serves as the conductive additive. The mixture 205 was loaded into a quartz tube 206, which was connected to a capacitor bank 201. See FIG. 2A (also Cu electrode 203, porous Cu 202, and graphite 204, as shown). The electric diagram and setup of the FJH system are similar to those described and shown in the Tour '111 PCT Application (such as shown in FIGS. 6, 13A, 30, and 41A therein). The resistance of the sample was controlled by the compressive force of the two electrodes; in most of trials, the resistance was fixed to be ~1Ω. See TABLE I.

TABLE I
Parameters For FJH

| | | | | | | Mass |
|---|---|---|---|---|---|---|
| | | | | | | after |
| | Mass | Mass | Resistance | Voltage | Time | FJH |
| Precursors | Ratio | (mg) | (Ω) | (V) | (s) | (mg) |
| CFA-F:CB | 2:1 | 150 | 1.0 | 60 | 1 | 125 |
| CFA-F:CB | 2:1 | 150 | 1.0 | 80 | 1 | 132 |
| CFA-F:CB | 2:1 | 150 | 1.0 | 100 | 1 | 58.4 |
| CFA-F:CB | 2:1 | 150 | 1.0 | 120 | 1 | 55.3 |
| CFA-F:CB | 2:1 | 150 | 1.0 | 150 | 1 | 43.7 |
| CFA-C:CB | 2:1 | 150 | 1.0 | 60 | 1 | 97.5 |
| CFA-C:CB | 2:1 | 150 | 1.0 | 80 | 1 | 90.0 |
| CFA-C:CB | 2:1 | 150 | 1.0 | 100 | 1 | 45.8 |
| CFA-C:CB | 2:1 | 150 | 1.0 | 120 | 1 | 50.2 |
| CFA-C:CB | 2:1 | 150 | 1.0 | 150 | 1 | 61.8 |
| CFA-F:metcoke | 2:1 | 150 | 1.5 | 120 | 1 | 81.2 |
| CFA-F:Plastic | 2:1 | 200 | 3.0 | 150 | 1 | 94.8 |
| Pyrolysis Ash | | | | | | |
| CFA-F-BC:CB | 2:1 | 150 | 1.0 | 60 | 1 | 54.0 |
| CFA-C-CWB:CB | 2:1 | 150 | 1.0 | 60 | 1 | 80.0 |
| BR:CB | 2:1 | 150 | 1.0 | 60 | 1 | 97.5 |

Too high or too low resistances result in inferior FJH reactions: a resistance too high does not afford high enough current for Joule heating, and a resistance too low does not generate enough heat. The detailed conditions for FJH that were tested are shown in TABLE I.

For a typical discharge with a voltage of 120 V and discharge time of 1 s, the current passing through the sample was recorded to be ~120 A at its maximum. See FIG. 2B. The fluctuation of the current curve is ascribed to the changing of sample resistance due to degassing or intrinsic temperature-dependent resistivity. The capacitor discharge produces a sample temperature of up to ~3000° C. in 5 ms (FIG. 2C), followed by rapid cooling. The temperature kept changing during the FJH process due to the sample resistance and current variation. Such a high temperature enables the vaporization of the heavy metals including Cd, As, Pb, Co, and Ni, according to their vapor pressure-temperature relationships. [Lide 2005]. See FIG. 2D (with the dashed line 211 denoting the temperature of 3000° C.). In contrast, the CB conductive additives is transformed to graphite-like carbon [Luong 2020], which does not sublime until ~3600° C. [Abrahamson 1974].

The heavy metal content in the residual solid after FJH were measured by ICP-MS, and their removal efficiencies were calculated as follows. Considering that the mass of CFA used for FJHis m (CFA), the concentration of heavy metals in CFA is measured as c (CFA), the mass of CB used for FJH is m (CB), the concentration of heavy metals in CB is measured as c (CB), the mass of the remaining solid (mixture of CFA and residual carbon) after FJH is m(CFA+CB), and the concentration of heavy metals in the remaining solid is measured as c(CFA+CB), the removal efficiency (R) by FJH is calculated using the following equation,

$$R = \frac{c ( CFA ) \times m ( CFA ) + c ( CB ) \times m ( CB ) - c ( CFA + CB ) \times m ( CFA + CB )}{c ( CFA ) \times m ( CFA ) + c ( CB ) \times m ( CB )} \times 100 \% \qquad ( 1 )$$

Similarly, when metcoke (MC) is used as the conductive additives, the removal efficiency is calculated by,

$$R = \frac{c ( CFA ) \times m ( CFA ) + c ( MC ) \times m ( MC ) - c ( CFA + MC ) \times m ( CFA + MC )}{c ( CFA ) \times m ( CFA ) + c ( MC ) \times m ( MC )} \times 100 \% \qquad ( 2 )$$

When Plastic Ash (PA) is used as the conductive additives, the removal efficiency is calculated by,

$$R = \frac{c ( CFA ) \times m ( CFA ) + c ( PA ) \times m ( PA ) - c ( CFA + PA ) \times m ( CFA + PA )}{c ( CFA ) \times m ( CFA ) + c ( PA ) \times m ( PA )} \times 100 \% \qquad ( 3 )$$

And when BR is used as the raw material, the removal efficiency is calculated by,

$$R = \frac{c ( BR ) \times m ( BR ) + c ( CB ) \times m ( CB ) - c ( CFA + CB ) \times m ( CFA + CB )}{c ( BR ) \times m ( BR ) + c ( CB ) \times m ( CB )} \times 100 \% \qquad ( 4 )$$

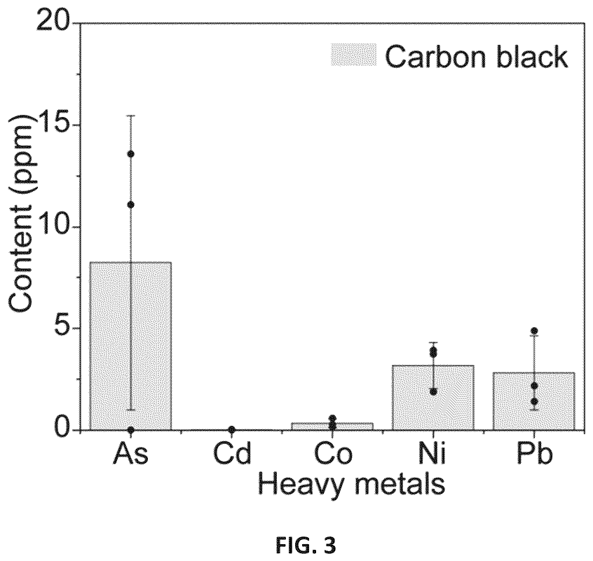

The heavy metal contents in the CB were 2-15% of those in CFA, a significant amount. See FIG. 3. The concentrations of heavy metal in CB were: As, ~8.23 ppm; Cd, 0.01 ppm; Co, ~0.34 ppm; Ni, ~1.13 ppm; and Pb, ~2.82 ppm. For comparison, the concentrations of heavy metal in CFA-F were: As, ~88.61 ppm; Cd, 0.62 ppm; Co, ~18.72 ppm; Ni, ~43.46 ppm; and Pb, ~28.33 ppm. The concentrations of heavy metal in CFA-C were: As, ~59.66 ppm; Cd, 0.76 ppm; Co, ~15.93 ppm; Ni, ~36.57 ppm; and Pb, ~22.84 ppm. Hence, the concentrations of heavy metal in CB are 1.7% to 9.9% of those in CFA-F, and 1.4% to 13.8% of those in CFA-C. As a result, the concentration of heavy metals in CB is statistically significant. Thus, in the calculation of the removal efficiencies, the combined total heavy metal content in CFA and CB was used as the baseline.

A series of FJH voltages ranging from 60 V to 150 V were applied (FIG. 2E with plots 221-225 for As, Cd, Co, Ni, and Pb, respectively) to purify CFA-F. The heavy metal removal efficiencies increased from 60 V to 120 V, which could be ascribed to a higher sample temperature produced by the higher FJH voltage. [Deng II 2022].

With a FJH voltage of 120 V, the heavy metal removal efficiencies were 70-90% by one FJH pulse. FIG. 2F. Further increasing the FJH voltage to 150 V did not increase the removal efficiencies (FIG. 2E), which could be due to inhomogeneous heating under excessive energy input. The evaporated heavy metals were deposited onto the sidewall of the quartz tube reactor or inside the sealed chamber, in avoidance of emission to the environment.

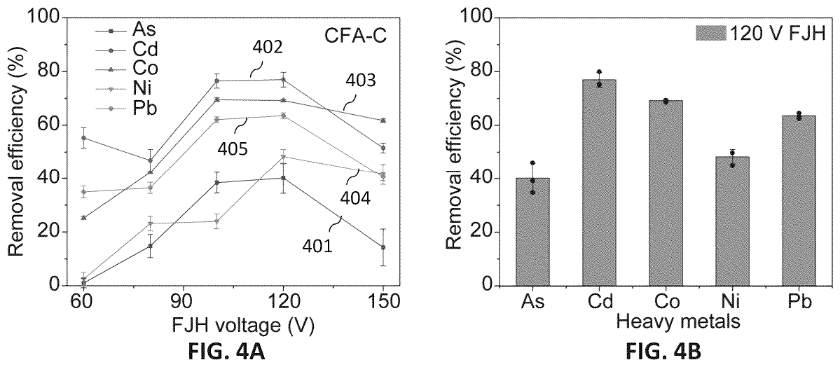

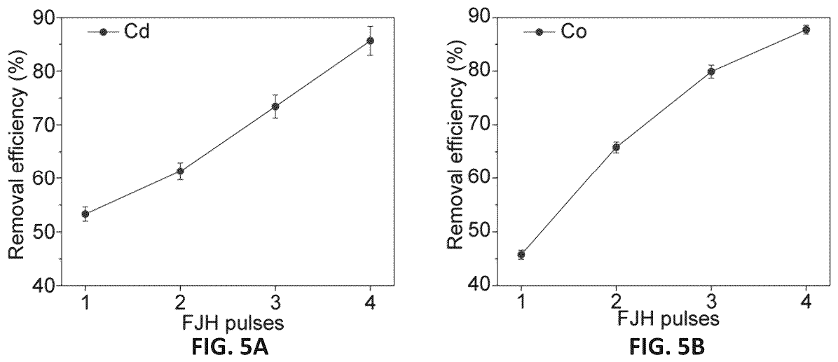

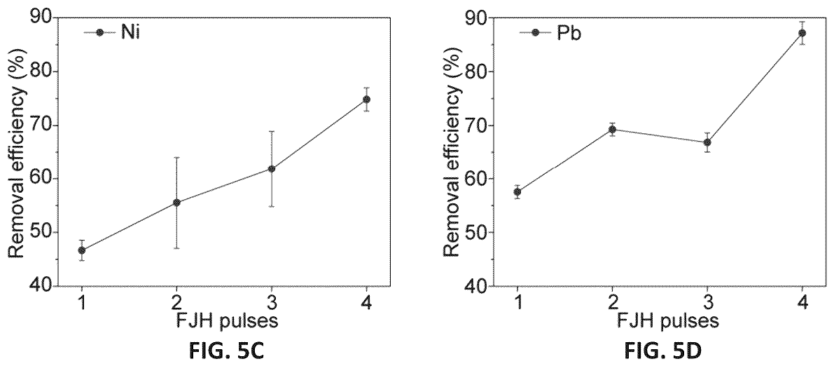

The CFA-C was also used as the starting materials. Under the FJH voltage of 120 V, the removal efficiencies achieve 40-80% for the representative heavy metals in a single voltage pulse. FIG. 4A (with plots 401-405 for As, Cd, Co, Ni, and Pb) and FIG. 4B. Generally, physicochemical adsorption methods rely on the capacity of sorbents, thus the heavy metal removal capacity is limited. [Bolan 2014]. In contrast, the FJH process has no capacity limit due to its evaporative removal feature. With multiple FJH pulse reactions, it was demonstrated that the removal efficiencies of heavy metals can be increased to >75% for Ni and >85% for Cd, Co, and Pb for CFA-C. FIGS. 5A-5D.

The heavy metals in CFA are present in the oxidized or natural ore forms, according to previous studies. [Koukouzas 2011; Rivera 2017; Liu P 2020]. Depending on the reactivity and thermal stability, the heavy metal species could evaporate in the natural form, or they could undergo thermal decomposition or carbothermic reduction to other compounds or elemental metals and then evaporate. In any case, the ultrahigh temperature by the FJH process would enable the chemical conversion and evaporation of the heavy metal species, which usually take place far below 3000° C. FIG. 6A (with plots 601-603 for the reactions shown below in Equations (5)-(7), respectively) and FIG. 6B (with plots 611-613 for PbCl₂, Pb, and PbO, respectively). The dash line 604 in FIG. 6A indicates ΔG=0 KJ mol⁻¹.

The heavy metals in CFA are in natural ore or oxides forms. Depending on the reactivity and thermal stability of these species, there are several scenarios: (1) the heavy metal species directly evaporate; (2) the heavy metals species thermally decompose to other compounds and then evaporate; and (3) the heavy metals compounds are carbothermic reduced to elemental metals and then evaporate. The FJH could achieve an ultrahigh temperature up to 3000° C., which is higher than the temperature required for each of these scenarios. Different speciation of lead (Pb, PbCl₂, PbO, PbS, and PbSO₄) were used an example for the thermodynamic analysis. Pb and PbCl₂ could directly evaporate. PbO could directly evaporate, or it can be carbothermic reduced to Pb(0) by the Equation (5):

$$PbO ( s ) + C ( s ) = Pb ( s ) + CO ( g ) \qquad ( 5 )$$

PbS could be converted to PbO by the Equation (6):

$$PbS ( s ) + 1.5 {O}_{2} ( g ) = PbO ( s ) + {SO}_{2} ( g ) \qquad ( 6 )$$

PbSO₄ could decompose to PbO by (Equation (7):

$${PbSO}_{4} ( s ) = PbO ( s ) + {SO}_{3} ( g ) \qquad ( 7 )$$

The Gibbs free energy change of these reactions (Equations (5)-(7)) using the software HSC Chemistry 10. See FIG. 6A. All these reactions are thermodynamically favorable below 2000° C. Moreover, the vapor pressure was calculated to vary with temperature for different Pb species. FIG. 6B. All these Pb species have a high vapor pressure below 2000° C. Since the FJH process can achieve a very high temperature of 3000° C., all above chemical conversion and evaporation processes are thermodynamically favorable and probably rapid. Above all, it was concluded that the FJH process is applicable to heavy metals removal regardless of their chemical states.

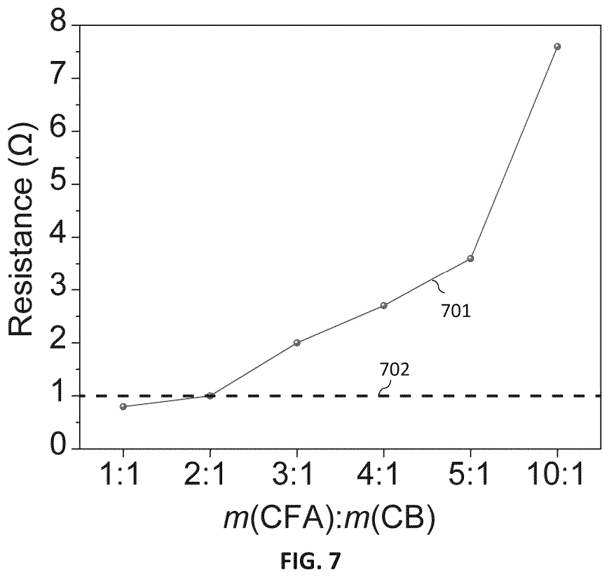

In certain embodiments, the mass ratio of CFA and CB of ~2:1 was preferable (see TABLE I), where the resistance of the sample was ~1Ω. See FIG. 7 (plot 701 showing sample resistance varied with such mass ratio and dash line 702 indicating R=1Ω).

In the FJH process, the sample resistance has import: if the resistance is too high, the current is not large enough to generate heating; in contrast, if the resistance is too low, the sample resembles a conductor and cannot generate enough heat neither. A resistance of ~1Ω has been found to be a preferred resistance in some embodiments for the FJH process.

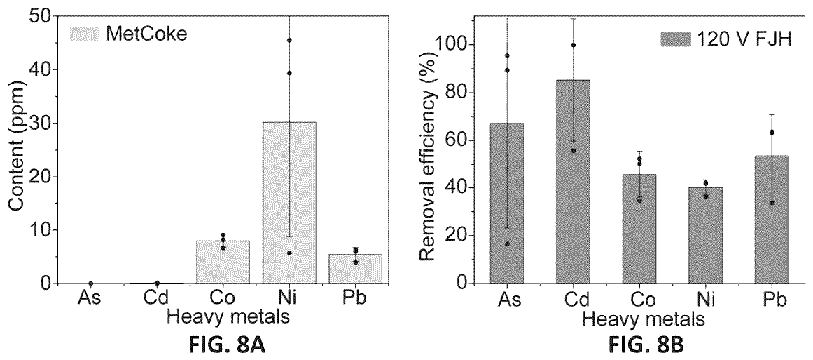

Other than CB, other inexpensive carbon could also be used as the conductive additive. For example, by using metallurgical coke (metcoke) as the conductive additive, the heavy metal removal efficiencies from CFA-F are 40-90% with one FJH pulse at a voltage of 120 V. FIGS. 8A-8B. The concentrations of heavy metal in metcoke are: As, below the ICP MS detection limit; Cd, 0.09 ppm; Co of ~7.95 ppm; Ni of ~30.2 ppm; and Pb of ~5.4 ppm. For comparison, the concentrations of heavy metal in CFA-F are: As, ~88.61 ppm; Cd, 0.62 ppm; Co, ~18.72 ppm; Ni, ~43.46 ppm; and Pb, ~28.33 ppm. Hence, the concentrations of heavy metal in CB are 0-69% of those in CFA-F. As a result, the concentration of heavy metals in CB is statistically significant. Again, in the calculation of the removal efficiencies of heavy metals, the total content of heavy metal in the combined CFA and CB is used as the baseline.

The removal efficiencies of heavy metal using metcoke as a conductive additive are somewhat smaller than those by using CB as additive FIG. 2F. CB has a better conductivity than that of metcoke (R~1.0Ω for CB, and R~1.5Ω for metcoke), thus the temperature would be higher for CB as conductive additive. In addition, CB has a much smaller average particle size of ~10 nm, while metcoke has an average particle size <150 μm. The difference in particle size is a reason that the heating uniformity is better when using CB as conductive additives.

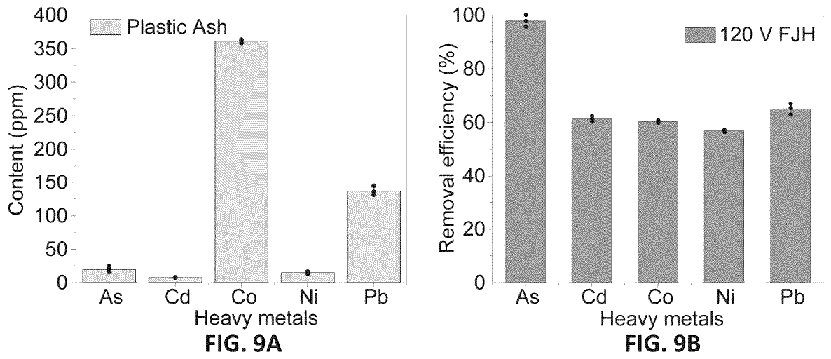

Moreover, plastic pyrolysis ash (Plastic Ash), the byproduct of plastic pyrolysis [Anuar Sharuddin 2016], was also used as the conductive additive. FIGS. 9A-9B. The removal efficiencies were >60% in a single FJH pulse. Considering the low or negative value of pyrolysis ash [Menya 2020], the material cost of the FJH purification process is presumed to be near zero. Under the same FJH parameters, the removal efficiencies using metcoke or Plastic Ash are somewhat smaller than those using CB as the additive (FIG. 2F). This may be due to the better conductivity of CB (R~1.0Ω for CB as additive, and R~3.0Ω for Plastic Ash as additive) and smaller particle size of CB, which permits a higher temperature and a more uniform heating. This can be compensated by increasing the FJH pulses (FIG. 5A-5D) when metcoke or Plastic Ash is used as the conductive additive.

After the FJH treatment process, there is considerable residual carbon content in the remaining solid. The residual carbon could be removed by calcination, which will be described hereinafter.

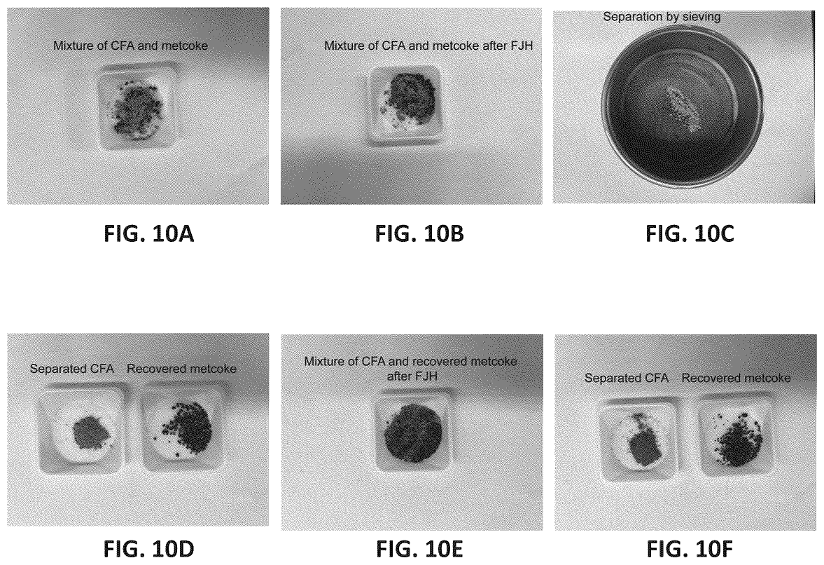

In addition, based on the particle size and density differences between CFA and carbon, it is feasible to separate residual carbon from CFA using physical processes. By using metcoke as an example, it has the separation of purified CFA and metcoke by sieving has been shown. The CFA has fine particle size, and metcoke with relatively large size was chosen for analysis. The mixture of CFA (~333 mg) and metcoke (~167 mg) were used. FIG. 10A. After FJH, the particle size of CFA and metcoke remained almost unchanged. FIG. 10B. Thus, separation of CFA and metcoke by sieving was performed. FIG. 10C. In a typical process, the recovered mass of metcoke was m (recovered metcoke)=154 mg; which was a metcoke recovery yield of ~92%. FIG. 10D.

The recovered metcoke could be reused as the conductive additive for further purification of CFA, which reduced the FJH purification cost. The recovered metcoke (154 mg) with some new metcoke (13 mg) as the conductive additives to purify the CFA (333 mg), as shown in FIG. 10E. After the FJH process and subsequent separation by sieving, the metcoke with mass of m (recovered metcoke)=156 mg was recovered and the metcoke recovery yield of ~93%. FIG. 10F.

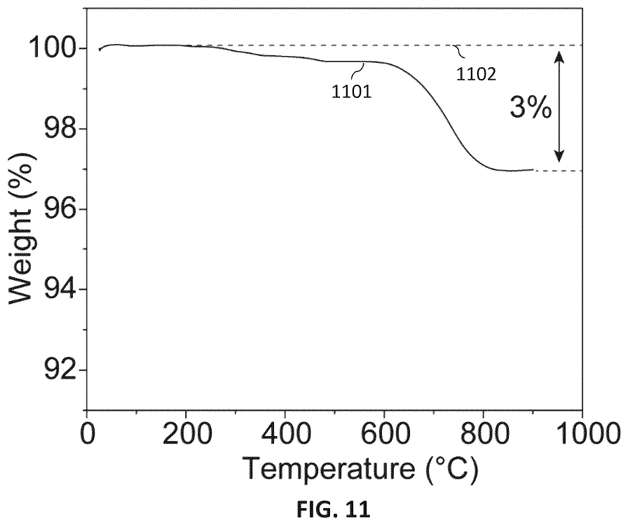

After the sieving separation process, the residual carbon content in the treated CFA (plot 1101) was reduced to ~3%. See FIG. 11 (with dashed line 1102 for 100 wt %). The residual carbon could be completely removed by calcination in air, which will be described hereinafter. The choice of appropriate carbon removal approaches can depend on the landfilling or applications of the purified CFA.

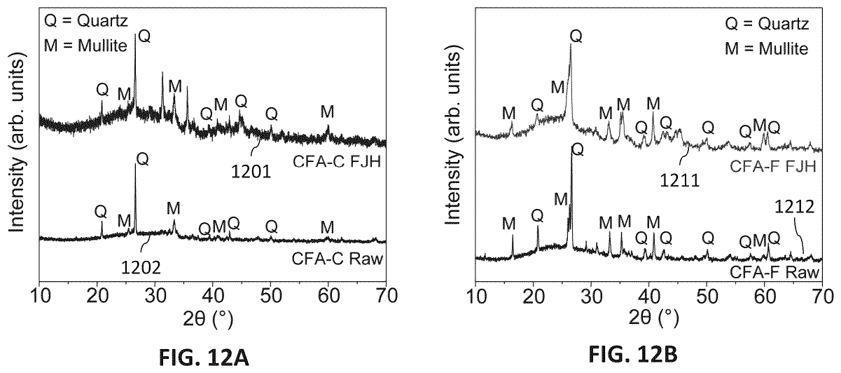

In addition to the trace heavy metals, the main composition of the residual solid was characterized. The crystal components remain quartz and mullite after FJH for both CFA-C and CFA-F, according to their XRD patterns. See FIG. 12A (with plots 1201-1202 for CFA-C FJH and CFA-C raw, respectively) and FIG. 12B (with plots 1211-1212 for CFA-F FJH and CFA-F raw, respectively).

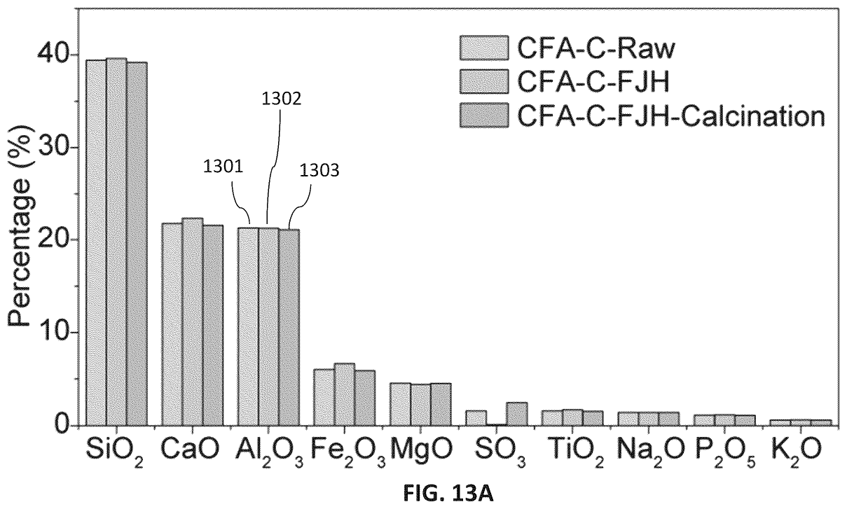

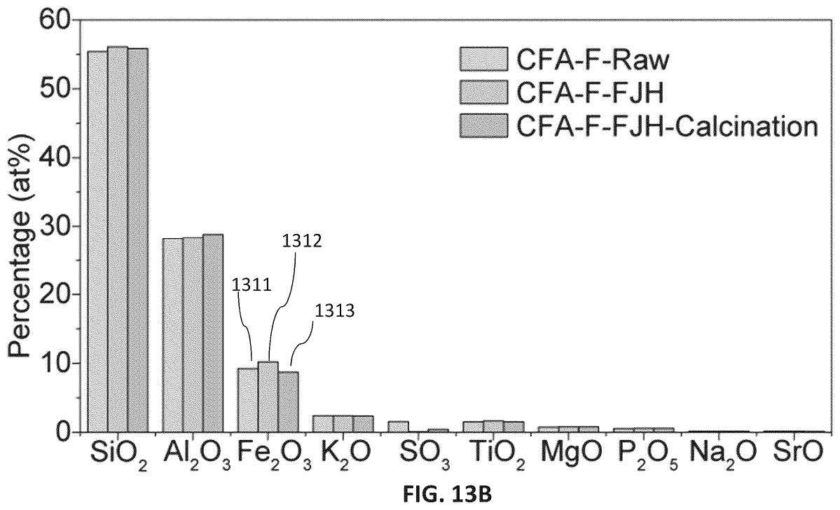

Since amorphous phases that are unable to be detected by XRD generally account for >60% of CFA composition [Chancey 2010], X-ray fluorescence (XRF) was also used to quantify the composition change. It has been found that the main composition, including various oxides, underwent little change after the FJH process, which is ascribed to the ultrafast heating and cooling rates and very short heating duration of the FJH process. See FIG. 13A (with bars 1301-1303 for CFA-C raw, CFA-C FJH and CFA-C FJH calcination, respectively) and FIG. 13B (with bars 1311-1313 for CFA-F raw, CFA-F FJH and CFA-F FJH calcination, respectively).

### Generality of the FJH Process for Heavy Metals Removal

The above described analysis showed that the FJH works for CFA of different classes. CFA from different geological origins can have significant variations in their trace heavy metal content. To demonstrate the generality of the FJH process for heavy metals removal, CFA from different sources were used as feedstocks, including CFA-C collected from Charah White Bluff (termed CFA-C-CWB), and CFA-F from Boral Cumberland (termed CFA-F-BC), both in the United States.

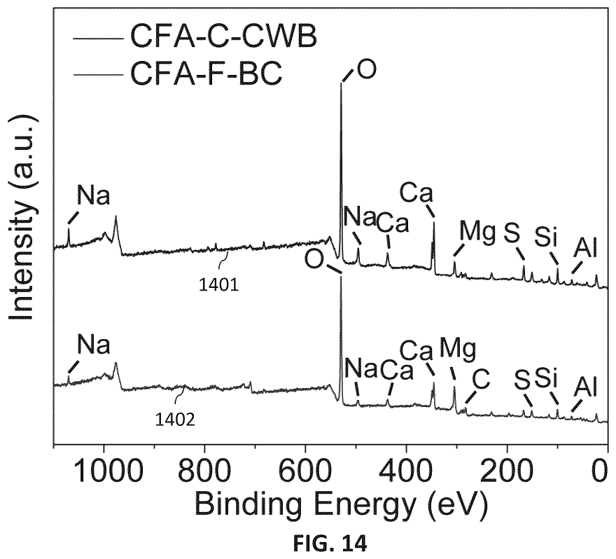

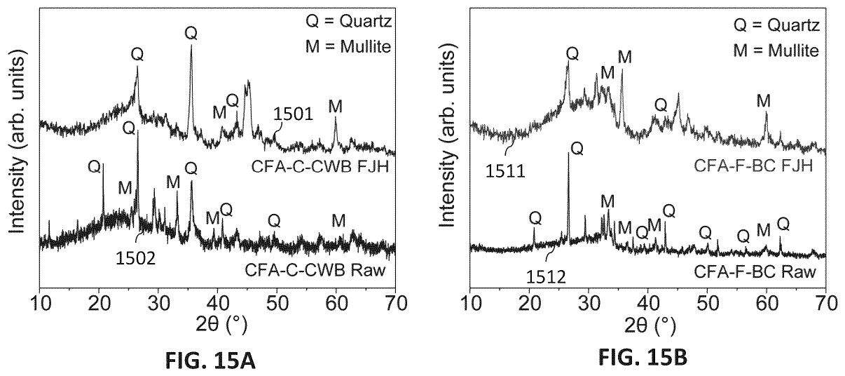

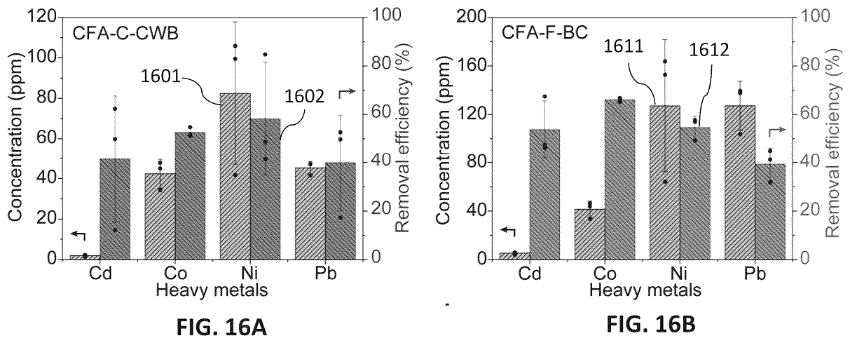

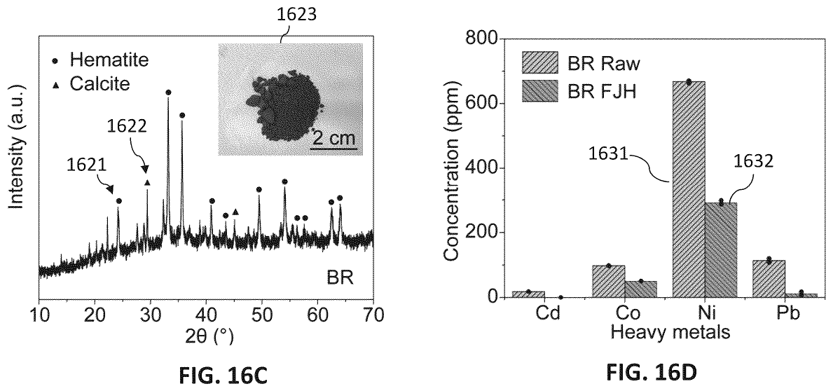

The main composition of CFA-F-BC and CFA-C-CWB are quartz and mullite, similar to those from App and PRB. See FIG. 14 (with plots 1401-1402 for CFA-C-CWB and CFA-F-BC, respectively) compared with FIG. 1B; FIG. 15A (with plots 1501-1502 for CFA-C-CWB FJH and CFA-C-CWB raw, respectively) compared with FIG. 12A; FIG. S14B (with plots 1511-1512 for CFA-F-BC FJH and CFA-F-BC raw, respectively) compared with FIG. 12B. The major heavy metals in CFA-C-CWB and CFA-F-BC were Cd, Co, Ni, and Pb. FIG. 16A for CFA-C-CWB (with bars 1601-1602 for concentration and removal efficiency, respectively) and FIG. 16B for CFA-F-BC (with bars 1611-1612 for concentration and removal efficiency, respectively).

At a FJH voltage of 120 V (TABLE I), the heavy metal removal efficiencies were 40-60% for CFA-C-CWB (FIG. 16A) and 40-70% for CFA-F-BC (FIG. 16B) using one FJH pulse, showing that the FJH process is a versatile process for CFA from different geological origins.

The FJH purification process can be further extended to other large-scale solid wastes, such as bauxite residue (BR), the by-product of the Bayer process for alumina production. [Deady 2016]. As one of the most abundant industrial wastes, BR has a production rate of 150 million tons per year in addition to the 3 billion tons already accumulated. [OchsenkuhnPetropulu 1996].

BR contains a significant content of heavy metals. [Service 2020]. BR is a red powder in its dry form (inset 1623 in FIG. 16C), and XRD shows the major components of hematite and calcite. FIG. 16C (with circles 1621 and triangles 1622 for hematite and calcite, respectively).

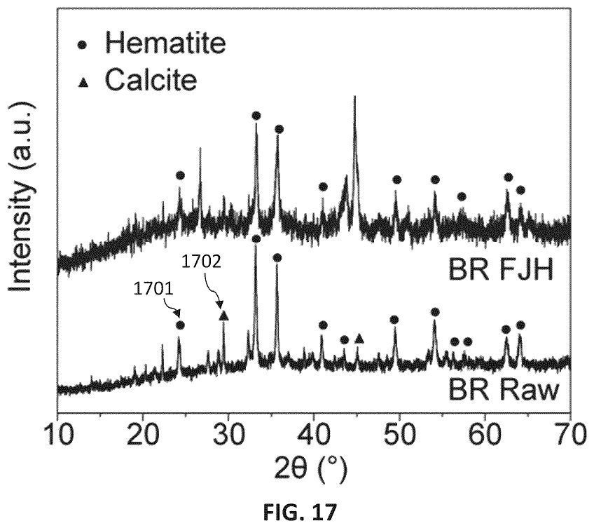

Similar to CFA, the BR was mixed with CB and the FJH process was conducted. TABLE I; and FIG. 17 (with circles 1701 and triangles 1702 for hematite and calcite, respectively). In BR, hematite and calcite are the major crystal components. After FJH, the hematite remains and the calcite was reduced, believed by Equation (8):

$$C a C {O}_{3} = C a O + C {O}_{2} \qquad ( 8 )$$

The abundant heavy metals in BR include Cd, Co, Ni, and Pb. FIG. 16D (with bars 1631-1632 for BR raw and BR FJH, respectively). After the FJH process, the heavy metal concentrations were significantly reduced (FIG. 16D), showing the generality of the FJH process for waste decontamination.

### Application of Purified CFA-C in Cement Composites

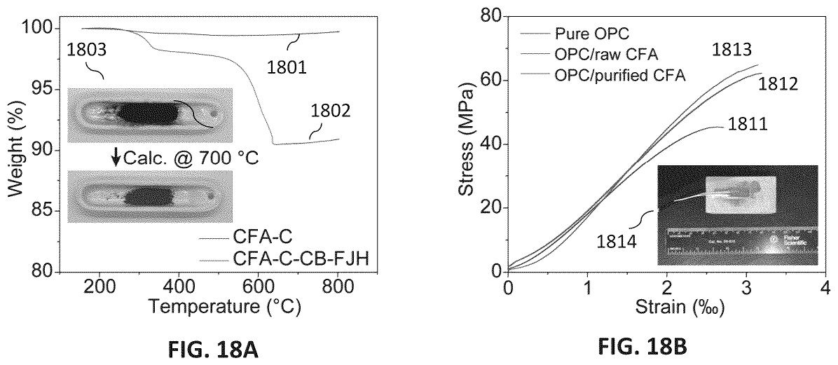

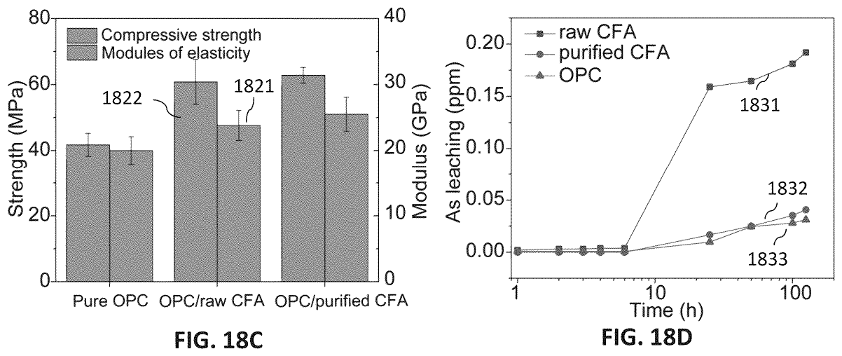

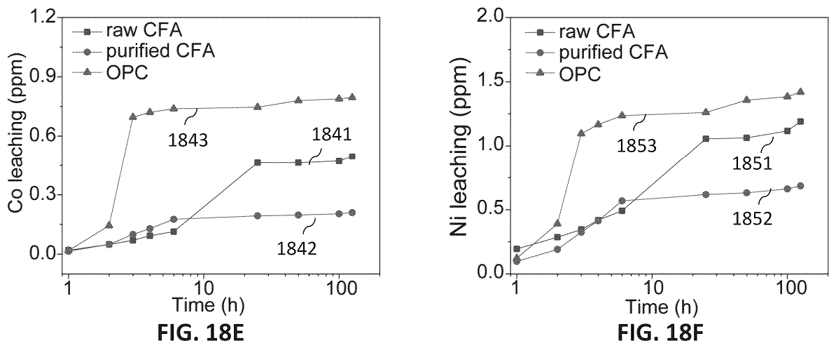

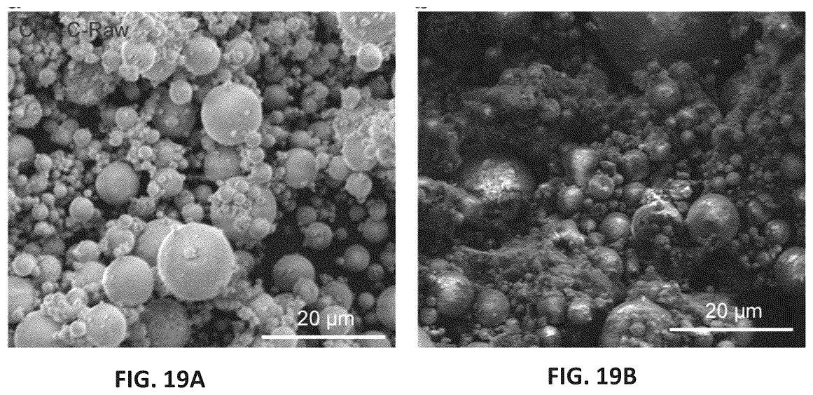

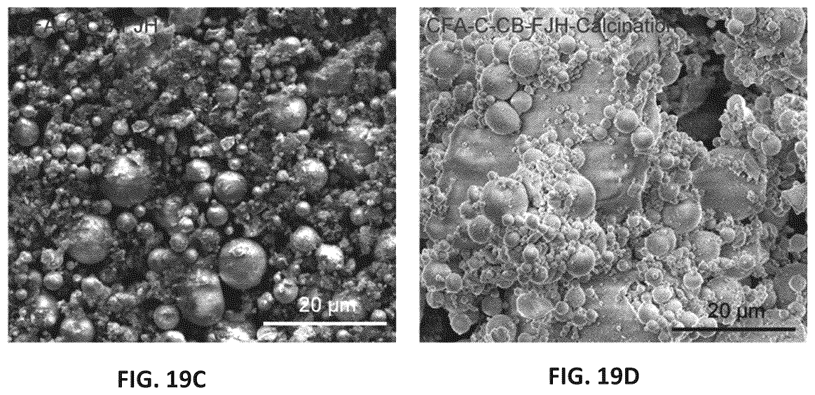

The CFA-C with a high content of CaO (~22 wt %, FIG. 13A) could be used as cementitious materials. [Rafieizonooz 2016; Canpolat 2004]. After the FJH reaction, the CFA-C contains ~10 wt % residual carbon according to the thermogravimetric analysis (TGA). FIG. 18A (with plots 1801-1802 for CFA-C and CFA-C-CB FJH, respectively). Prior to use, the residual carbon was removed by calcination in air at 700° C. for 1 h (inset 1803 in FIG. 18A). It is noted that the calcination process does not change the main composition of CFA-C according to the XRF analysis (FIG. 13A). In addition, the FJH and calcination processes do not substantially change the microscopic morphology of the CFA-C materials. See FIGS. 19A-19D.

The purified CFA-C was used to substitute 30 wt % of OPC for cement composite (termed OPC/purified CFA), and pure OPC cement (termed Pure OPC) and the raw CFA-C substituted to 30 wt % of OPC (termed OPC/raw CFA) were tested as controls.

The removal of residual carbon in CFA after the FJH was done by calcination at 700° C. for 1 h in air using a furnace (NEY 6-160A). The cement used for the analysis was Portland cement type I/II. Three kinds of cement specimens were cast: (a) Pure OPC, (b) OPC/raw CFA, and (c) OPC/purified CFA. This mass ratio (CFA:OPC=3:7) is considered a moderate dosage of CFA for cement-based material to improve the mechanical properties without extending set time and slowing strength development. [Thomas 2007]. All cement specimens were cast with a water:cement weight ratio of 0.6, removed from the molds after 24 h, and then cured in water for 1 day or 28 days before testing. The dimensions of the cast specimens were 25.4×25.4×50.8 mm³ with the shape of rectangular prisms, as shown in inset 1814 of FIG. 18B. The cured specimens were tested on a uniaxial compressive machine with a loading rate of 1.29 mm min⁻¹.

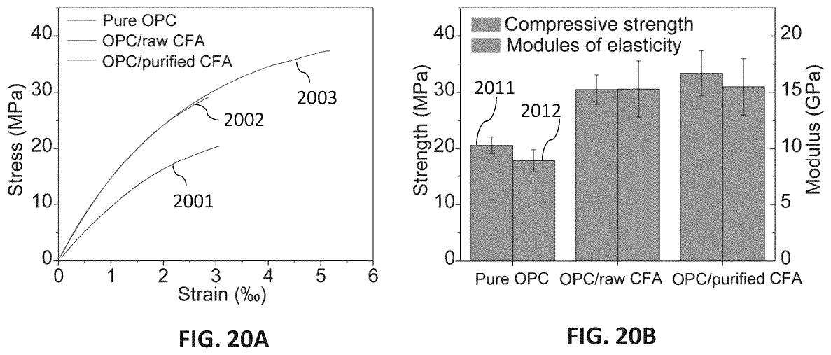

After only one day of curing, the compressive strength and modulus of elasticity of the OPC/purified CFA composites achieved 33.4 MPa=4.0 MPa and 15.5 GPa 15.5±2.5 GPa, respectively, is much greater than those of Pure OPC at 20.6 MPa and 8.9 GPa, respectively. FIG. 20A (with plots 2001-2003 for Pure OPC, OPC/raw CFA, and OPC/purified CFA, respectively) FIG. 20B (with bars 2011-2012 for compressive strength and modules of elasticity, respectively), and TABLE II. I.e., the compressive strength of the OPC/purified CFA exhibited ~62% increase compared with that of the Pure OPC; and the modulus of elasticity of OPC/purified CFA was ~74% higher than that of the pure OPC. In addition, the performance of OPC/purified CFA was comparable to those of the OPC/raw CFA.

TABLE II
Application Of CFA In Cement

| | | | OPC with | OPC with |
|---|---|---|---|---|
| | | | 30 wt % | 30 wt % |
| | | OPC | raw CFA | purified CFA |
| Compressive | 28 day | 41.7 | 60.8 | 62.8 |
| strength (MPa) | 1 day | 20.6 | 30.5 | 33.4 |
| Modulus of | 28 day | 20.0 | 23.8 | 25.5 |
| elasticity (GPa) | 1 day | 8.9 | 15.3 | 15.5 |

The representative stress-strain curves 1811-1813 of, respectively, Pure OPC, OPC/raw CFA, and OPC/purified CFA after curing for 28 days are shown in FIG. 18B. The compressive strength of the OPC/purified CFA is 62.8±2.4 MPa, exhibiting ~51% increase compared with that of the Pure OPC. FIG. 5C (with bars 1821 for compressive strength); TABLE II. The modulus of elasticity of OPC/purified CFA is 25.5±2.6 GPa, which is ~28% greater than that of the Pure OPC. FIG. 5C (with bars 1822 for modulus of elasticity); TABLE II. In addition, the performance of OPC/purified CFA was comparable to those of the OPC/raw CFA. This is probably because the composition (FIG. 13A) and particle size and morphology (FIGS. 19A-19D) of the CFA remained similar after the FJH purification process, except for the lowered heavy metal content.

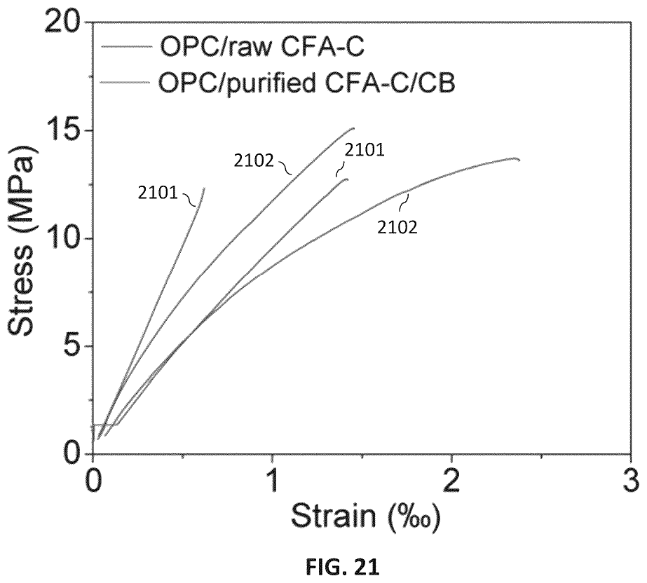

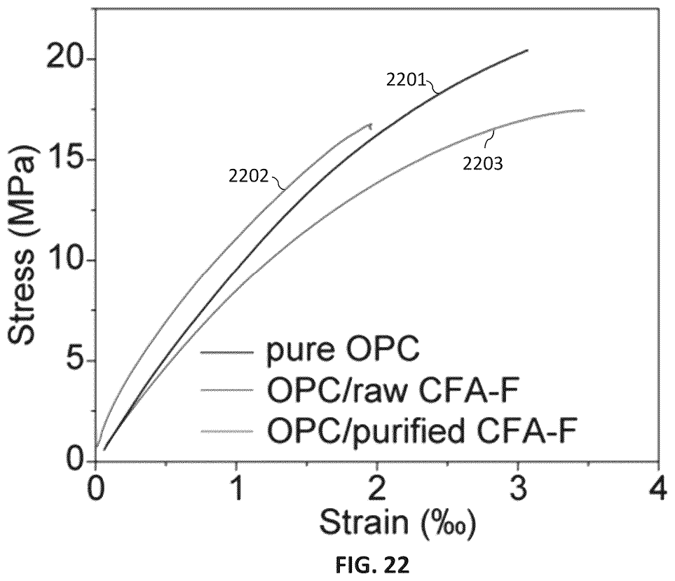

Applicant has previously shown that appropriate loading (~0.15 wt %) of flash graphene into OPC promotes the composite's compressive strength [Luong 2020; Wyss 2021; Advincula 2021]. However, the as-obtained CFA-C/CB after FJH has a high residual carbon content of ~10 wt %. To avoid a calcination process to remove the residual carbon, as-obtained purified CFA-C/CB was further used to substitute 5 wt % OPC, thus with a nominal carbon content of ~0.5 wt %. The resulting purified CFA-C/CB substituted cement showed a performance similar to that of raw CFA-C. FIG. 21 (with plots 2101-2102 for OPC/raw CFA-C and OPC/purified CFA-C/CB, respectively). In addition to CFA-C, the purified CFA-F was also used to substitute 30 wt % OPC, which exhibits comparable performance compared to pure OPC. FIG. 22 (with plots 2201-2203 for Pure OPC, OPC/raw CFA-F, and OPC/purified CFA-F).

To mimic the acid rain leaching conditions, three cement pastes made from Pure OPC, raw CFA-C, and purified CFA-C were put into a pH 4 HNO₃ solution, and the accumulated heavy metals were measured from 1 to 125 h. Three types of cement specimens were prepared using Pure OPC, raw CFA-C, and purified CFA-C, with the solid mass of 0.25 g. All specimens were cast with water:cement weight ratios of 0.6 for 24 h and then cured in water for another 24 h. To mimic acid rain conditions, the specimens were separately put into a 0.0001 M HNO₃ solution (10 mL) with pH of 4. The heavy metal contents in the leachate after 1 h, 2 h, 4 h, 6 h, 25 h, 50 h, 100 h, and 125 h were measured by ICP-MS. The accumulated heavy metal content in the leachant vs. the leaching time was plotted.

As shown in FIG. 18D, the raw CFA-C (plot 1831) had a serious As leaching up to ~0.2 ppm; in contrast, the purified CFA-C (plot 1832) showed much less As leaching, comparable to pure OPC (plot 1833). In addition, the pure OPC exhibits the most severe Co (FIG. 18E with plots 1841-1843 for raw CFA-C, purified CFA-C, and OPC, respectively) and Ni (FIG. 18F with plots 1851-1853 for raw CFA-C, purified CFA-C, and OPC, respectively) leaching, while both are substantially lessened for the purified CFA-C. Hence, the purified CFA-C could be more environmentally friendly than OPC when considering heavy metal leakage, serving as another incentive for the application of purified CFA in real-world applications.

### Techno-Economic Analysis and Life Cycle Analysis

The FJH process for CFA purification has good scalability. The evaporative removal of the heavy metals can depend on the maximum temperature during FJH; hence, maintaining a constant temperature can have import for scaling up the FJH process.

### Scaling Rule of FJH Process by Theoretical Analysis

A theoretical analysis of the FJH process was conducted, which demonstrated that the sample mass per batch could be increased by linearly increasing the FJH voltage or the total capacitance.

For the evaporative separation process, the removal efficiencies of the heavy metals rely on the maximum temperature; hence, the available temperature across the sample will have import when scaling up the FJH process. For the Joule heating process, the heat amount (Q) is calculated by Equation (9).

$$Q = {I}^{2} R t \qquad ( 9 )$$

where I is the current passing through the sample, R is the resistance, and t is the discharge time.

The heat amount per volume (Qᵥ) is calculated by Equation (10).

$${Q}_{v} = {j}^{2} {ρ}_{e} t , \qquad ( 10 )$$

where j is the current density, and ρₑ is the electrical resistivity.

The temperature change (ΔT) is proportional to the heat amount by Equation (11).

$$Q = {C}_{p} m Δ T , \qquad ( 11 )$$

where C_{P} is heat capacity and m is the mass of the sample.

The above equation can be reformulated per volume to Equation (12).

$${Q}_{v} = {C}_{p} {ρ}_{m} Δ T , \qquad ( 12 )$$

where ρₘ is the density of the sample.

For a specific sample, the Cₚ and ρ were constant; hence, maintaining a constant Qᵥ is critical to keep the same temperature during FJH.

For a specific sample, the electrical resistivity (ρₑ) is constant; hence, to maintain a constant Qᵥ when increasing the sample mass, it is necessary to keep a constant j, according to Equation (10).

The charge amount (q) in the capacitor bank can be calculated by Equation (13).

$$q = C V , \qquad ( 13 )$$

where C is the capacitance of the capacitor bank, and V is the voltage of the capacitor bank.

Assuming that all the charges in the capacitor bank are discharged within the time t, the current (I) through the sample can be calculated by Equation (14).

$$I = \frac{q}{t} \qquad ( 14 )$$

As a result, the current density (j) can be calculated by Equation (15).

$$j = \frac{I}{S} = \frac{CV}{St} , \qquad ( 15 )$$

where S is cross-sectional area of the sample.

For a cylinder-shaped sample, which was usually the case in the FJH apparatus utilized for the testing performed and described herein, the mass (m) can be calculated by Equation (16)

$$m = {ρ}_{m} SL , \qquad ( 16 )$$

where ρₘ is the density of the sample, S is the cross-sectional area of the sample, and L is the length of the sample.

For a specific sample type, the density (ρₘ) is kept the same.

To summarize, Equation (17) can be obtain that determines the current density.

$$j = \frac{CV {ρ}_{m} L}{mf} \qquad ( 17 )$$

As we have described above, when increasing the mass (m) of the sample, the current density (j) passing through the sample can be (and generally is) kept constant. This can be realized by the following measures: (1) increasing the FJH voltage (V), and/or (2) increasing the capacitance (C).

### Scaling Up to Gram-Scale Per Batch

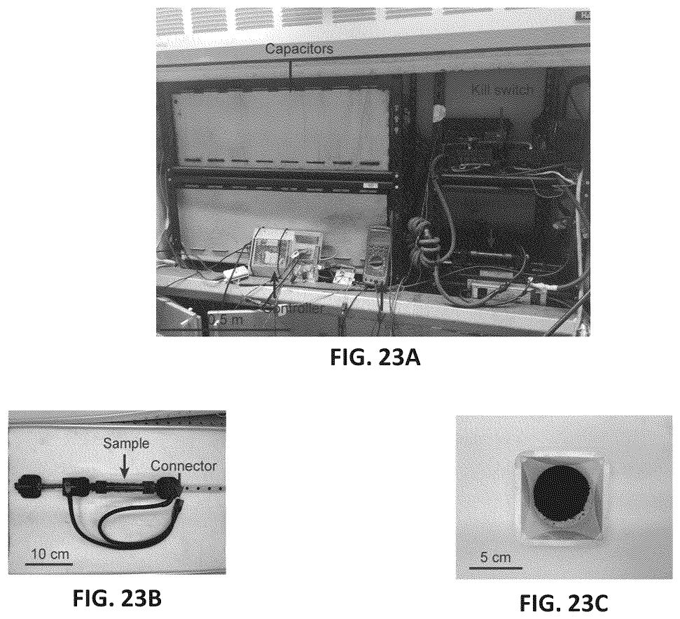

By building a FJH system with large capacitance of C=0.624 F, the sample mass up to 3 g per batch has been demonstrated. See FIGS. 23A-23C.

In this first-generation FJH setup, a capacitor bank composed of 10 aluminum electrolytic capacitors (450 V, 6 mF, Mouser #80-PEH200YX460BQU2) with a total capacitance of C₀=0.06 F. In a small-scale experiment, the FJH voltage of V₀=120 V and capacitance of C₀=0.06 F were used for a sample mass of m₀=0.15 g. The scaling up of the FJH to a mass of m₁=3 g was next demonstrated. A second-generation FJH setup was built with larger capacitance of C₁=0.624 F. FIG. 23A. According to Equation (16), Equation (18) is obtained.

$$\frac{{m}_{1}}{{m}_{0}} = \frac{{c}_{1} {V}_{1}}{{c}_{0} {V}_{0}} \qquad ( 18 )$$

For a mass of m₁=3 g and C₁=0.624 F, a FJH voltage of V₁=250 V was used, thus basically fitting with Equation (18). Further adjustments of the FJH process, including the conductive additive content, the FJH voltage, and FJH time, can be utilized when scaling up the process.

### Scaling Up And Continuous Process

By using a 3D printed automation system, a production rate of >10 kg day⁻¹ of flash graphene (from metcoke) was obtained in the research laboratory of Applicant. This system was built for the process of conversion of carbon sources into flash graphene that was discovered by Applicant. [Luong 2020]. The flash temperature in that process was 3100° C.

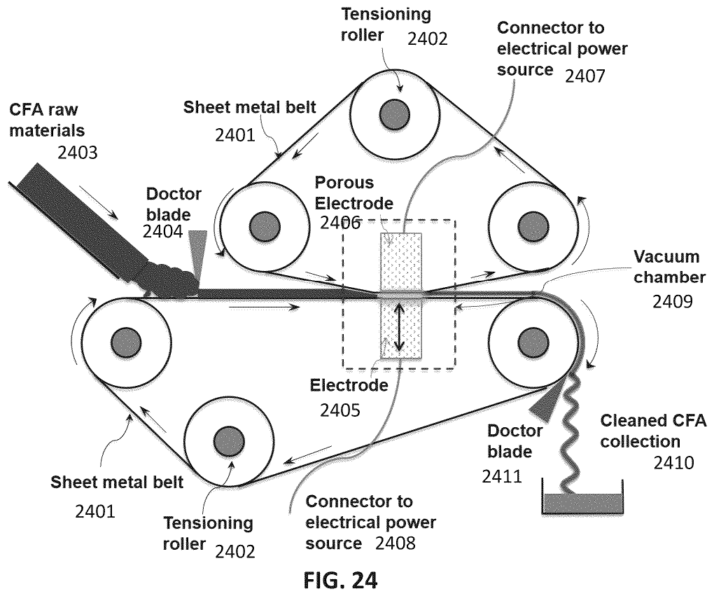

The FJH process could thus be integrated with scaling-up techniques for continuous processing. FIG. 24. The FJH process can be integrated with industrially available process for continuous running using a belt roller. As shown in FIG. 24, a sheet metal belt 2401 controlled by the tensioning roller 2402 can be used for converting the CFA raw materials 2403. Doctor blade 2404 can be used to control the thickness and the compactness of the CFA raw materials. During FJH, since the sheet metal is not a good electrical conductor along its length, the current can be concentrated where the electrodes 2405-2406 are located (each having a connector to electrical power source 2407-2408). The FJH zone can be placed in a vacuum chamber 2409 to collect the volatiles. The clean CFA can be collected at collector 2410 (with doctor blade 2411 that can be used to control the thickness and other sizing of the cleaned CFA).

### Energy Consumption And Costs

The energy consumption and cost of the FJH purification process has been investigated. Joule heating is a highly efficient technique with a coefficient of performance of nearing 1.0 since almost all the electrical energy directly targets sample heating. This is in strikingly contrast to a traditional furnace that relies on thermal conduction to heat the sample, leading to reduced energy efficiency. Because of the ultrafast heating and cooling rates and the short processing time within 1 s, the FJH process for heavy metal removal from CFA has an estimated electricity consumption of ~532 kWh ton⁻¹, or $21 ton⁻¹ using an industrial electricity rate)

The materials cost could be minimized by recovering and reusing the conductive additives, or by using conductive additives with low-cost or negative valued carbon such as Plastic Ash.

### Life Cycle Analysis

A comparative cradle-to-gate life cycle analysis (LCA) was conducted to examine the environmental impact and energy demand resulting from the disposal of CFA as compared to the reuse of unpurified or purified CFA as alternative cementitious materials. The LCA further confirmed the value of the present invention, including in view of the GHG emissions and heavy metal emissions reduction by the newly established FJH and partial substitution strategy, as well as its energy consumption demands. This analysis was conducted under the requirements of ISO 14044.

The analysis covered three main steps: raw material production, feedstock preparation, and landfilling. Transportation was considered in the landfill steps, and a lab-scale process is assumed for FJH with no further scaling being applied. The functional unit considered was 1 ton of cementitious materials. A complete life cycle inventory is included in TABLES III-VII below. Direct energy inputs for the FJH process were measured experimentally, and values from the ISO compliant Argonne National Laboratory GREET LCA database or literatures were used to calculate cumulative demands and impacts.

### Scenario Description And System Boundaries

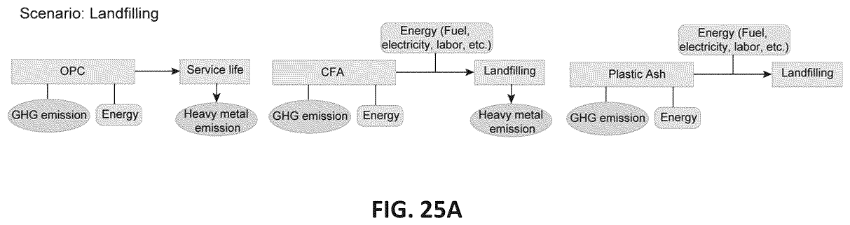

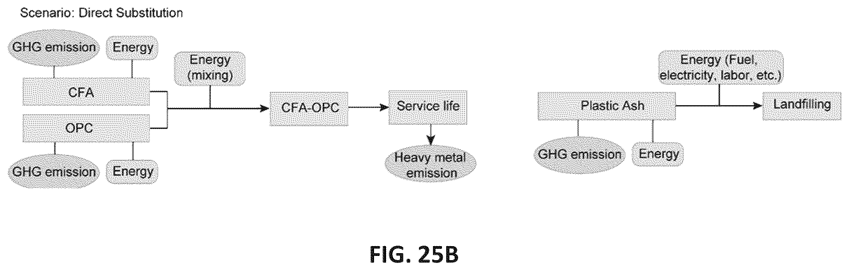

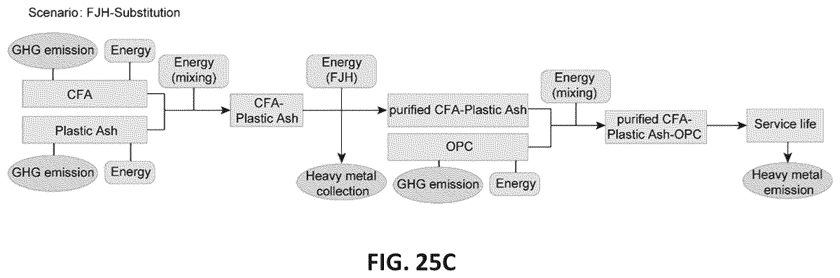

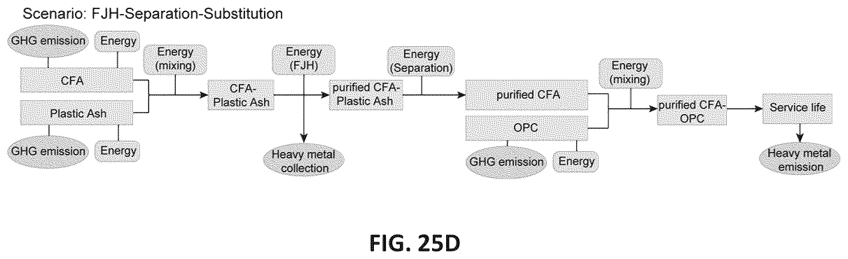

Four scenarios were considered, namely, (a) Landfilling (pure OPC as cement for service life, and CFA and Plastic Ash being landfilled), (b) Direct Substitution (OPC-raw CFA composite as cement for service life, and Plastic Ash being landfilled), (b) FJH-Separation-Substitution (CFA purified by FJH followed by the removal of residual carbon by separation, and OPC-purified CFA composite as cement for service life), and (d) FJH-Substitution (CFA purified by FJH without the removal of residual carbon, and OPC-purified CFA-Plastic Ash composite as cement for service life). See FIGS. 25A-25D.

In all the scenarios, 1 ton of cementitious materials for service life was used as the baseline and all other materials flow are normalized according to the cementitious materials. See TABLE III

TABLE III
Materials Flow For Various Scenarios

| | | Direct | FJH- | |
|---|---|---|---|---|
| | Land- | Substi- | Separation- | FJH- |
| | filling | tution | Substitution | Substitution |
| Scenarios | (ton) | (ton) | (ton) | (ton) |
| OPC (service life) | 1 | 0.7 | 0.7 | 0.95 |
| CFA (service life) | 0 | 0.3 | 0.47 | 0.07 |
| Plastic Ash (service | 0 | 0 | 0.23 | 0.04 |
| life) | | | | |
| Purified CFA (service | 0 | 0 | 0.3 | 0.05 |
| life) | | | | |
| Mixing (CFA + OPC) | 0 | 1 | 1 | 1 |
| Mixing (CFA + Plastic | 0 | 0 | 0.7 | 0.11 |
| Ash) | | | | |
| FJH (CFA + Plastic | 0 | 0 | 0.7 | 0.11 |
| Ash) | | | | |
| Separation (purified | 0 | 0 | 0.333 | 0 |
| CFA + Plastic Ash) | | | | |
| CFA (landfill) | 0.47 | 0.17 | 0 | 0.4 |
| Plastic Ash (landfill) | 0.23 | 0.23 | 0 | 0.19 |

Note:
The materials mass flow is normalized to 1 ton of cementitious materials in service life.

Scenario 1 Landfilling: In this scenario (FIG. 25A), the pure OPC (1 ton) is used for the service life in cement, and the CFA (0.47 ton) and Plastic Ash (0.23 ton) are landfilled. Note that the mass of CFA and Plastic Ash are assigned according to their consumption in the FJH-Separation-Substitution scenario. See details in Scenario 3, below.
Scenario 2 Direct Substitution: In this scenario (FIG. 25B), the cement application (FIGS. 18B-18C) is used in which the OPC is substituted with 30 wt % raw CFA. Hence, in this scenario, the OPC (0.7 ton) is mixed with raw CFA (0.3 ton) for the service life in cement. In this scenario, the Plastic Ash (0.23 ton) and part of CFA (0.17 ton) is landfilled to compensate the materials consumption in Scenario 3 (detailed below). The landfill energy consumption is the same as Scenario 1, above.
Scenario 3 FJH-Separation-Substitution: In this scenario (FIG. 25C), the Plastic Ash is used as the conductive additive. The CFA (0.47 ton) is mixed with 33 wt % Plastic Ash (0.23 ton), and the 0.7 tons undergo FJH to remove the heavy metals, which leading to a mixture of purified CFA-Plastic Ash (0.33 ton). The residual carbon in the mixture of purified CFA-Plastic Ash is separated by sieving (FIGS. 10A-10F), yielding the purified CFA (0.3 ton). In our cement application (FIGS. 18B-18C), the OPC is substituted with 30 wt % purified CFA. Hence, the OPC (0.7 ton) is mixed with the purified CFA (0.3 ton) as the service life in cement. No material is landfilled in this scenario.
Scenario 4 FJH-Substitution: In this scenario (FIG. 25D), the Plastic Ash is used as the conductive additive. The CFA (0.07 ton) is mixed with 33 wt % Plastic Ash (0.04 ton), and the 0.11 ton undergo FJH to remove the heavy metals, which leading to a mixture of purified CFA-Plastic Ash (0.05 ton). Using the cement application of FIG. 21, the OPC is substituted with 5 wt % purified CFA-Plastic Ash without the separation process. Hence, the OPC (0.95 ton) is mixed with the purified CFA-Plastic Ash (0.05 ton) for the service life in cement. In this scenario, some portion of CFA (0.4 ton) and Plastic Ash (0.19 ton) are landfilled to compensate the materials consumption in Scenario 3 described above.

### Life Cycle Inventory

The environmental impacts, including GHG emission and heavy metal emission, and energy consumption demand, for the raw materials production, processing, and landfilling are summarized in TABLE IV, with further explanation of the value below.

TABLE IV
Life Cycle Inventory

| | GHG | | Energy |
|---|---|---|---|
| | emission | Heavy metal | consumption |
| Impact Category | (kg) | emission (g) | (MJ) |
| OPC (service life) | 849.4969 | 2.24593 | 4581 |
| CFA (service life) | 10.1 | 1.8788 | 199 |
| Plastic Ash (service life) | 0.028 | 0 | 5.94 |
| Purified CFA (service life) | 0 | 0.93593 | 0 |
| Mixing (CFA + OPC) | 0 | 0 | 9.432 |
| Mixing (CFA + Plastic Ash) | 0 | 0 | 9.432 |
| FJH (CFA + Plastic Ash) | 0 | 0 | 2901.6 |
| Separation (purified | 0 | 0 | 4 |
| CFA + Plastic Ash) | | | |
| CFA (landfill) | 0 | 1.8788 | 19.6 |
| Plastic Ash (landfill) | 0 | 0 | 19.6 |

Note:
The environmental impacts or energy demands are normalized to production, processing, or landfilling of 1 ton of materials.

Materials production: The GHG emission (849.50 kg ton⁻¹) and energy consumption (4581 MJ ton⁻¹) for OPC is from the Argonne GREET model. The GHG emission (10.1 kg ton⁻¹) and energy consumption (199 MJ ton⁻¹) of CFA is from the literature. [Teixeira 2016]. The GHG emission and energy consumption of Plastic Ash is unavailable; here, the biomass ash data are used as an alternative due to their similar process (GHG emission at 0.028 kg ton⁻¹, energy consumption at 5.94 MJ ton⁻¹). [Teixeira 2016].

Service life as cement: It is assumed that the heavy metal emissions to the surrounding environments take place in the service life of cement. The heavy metal emission is defined as the total leaching contents of As, Co, and Ni. The leachable As, Co, and Ni contents in cement reach a plateau according to the acid leaching experiments (FIGS. 18D-18F); hence, the leachable heavy metal content at 125 h is used as the heavy metal emission in the service life of cement. Accordingly, the heavy metal emissions for pure OPC, raw CFA, and purified CFA are designated to be 2.25 g ton⁻¹, 1.88 g ton-1, and 0.94 g ton⁻¹, respectively. When a mixture of cement composite is used, the heavy metal emission is normalized according to their mass ratio. Therefore, the heavy metal emission for the OPC substituted with 30 wt % raw CFA, the OPC substituted with 30 wt % purified CFA, and the OPC substituted with 5% purified CFA are calculated to be 2.14 g ton⁻¹, 1.85 g ton-1, and 2.18 g ton⁻¹, respectively.

Landfilling: It is assumed that heavy metal emissions take place in the landfilling of CFA. The heavy metal emission from CFA landfilling is defined as the total leachable contents of As, Co, and Ni, which are assigned as the plateau content at 125 h, i.e., 1.88 g ton⁻¹, in the acid leaching experiments (FIGS. 18D-18F). The heavy metal emission from Plastic Ash landfilling is not being considered in the analysis. Since CFA is mostly composed of inorganics and Plastic Ash is mostly composed of graphitized carbon that is very stable in environment, it is assumed here that there is no GHG emission during the landfilling of CFA and Plastic Ash. Energy input is necessary for the landfilling of CFA and Plastic Ash. According to a recent literature [Nabav-Pelesaraei 2017], the landfill energy consumption is ~19.6 MJ ton⁻¹, including human labor, diesel fuel, transportation, electricity, etc. This energy is assigned to the energy consumption of CFA and Plastic Ash landfilling.

Processing—Mixing: Energy input is needed for the mixing process, including the mixing of raw CFA and Plastic Ash for FJH, and the mixing of non-purified or purified CFA and OPC for cement. It is assumed that the mixing is conducted using an electricity driven Powder Mixer with the energy consumption of 9.432 MJ ton⁻¹. No GHG emission and heavy metal emission in the mixing process.

Processing—FJH: The energy consumption for FJH was estimated to be 2901.6 MJ ton⁻¹. Heavy metal is collected in the FJH process thus no heavy metal emission at this step.

Processing—Separation by sieving: It is assumed that the separation is conducted using an industrial vibrating sieving machine. For a typical shaker machine, the capacity is estimated to be m=0.034 ton according to its volume. The powder is 80 W. If a processing time of 0.5 h is assumed, the separation energy consumption is estimated to be ~4 MJ ton⁻¹. The separation process has no heavy metal or GHG emissions.

### Life Cycle Impact Assessment

In the LCA, the environmental impacts were categorized into 3 midpoint indicators, including heavy metal emissions (TABLE V), GHG emissions (TABLE VI), and energy consumptions (TABLE VII).

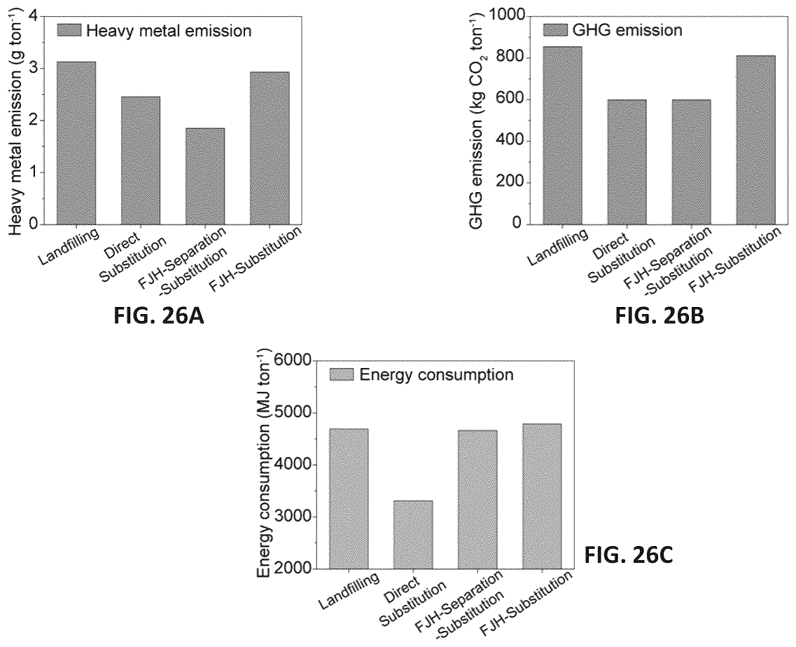

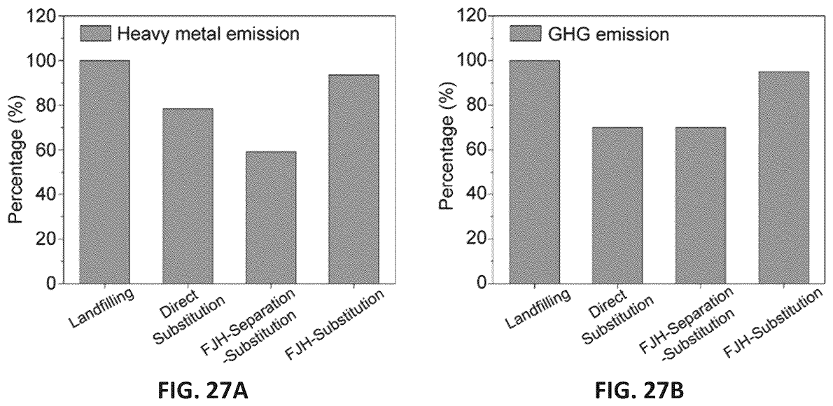

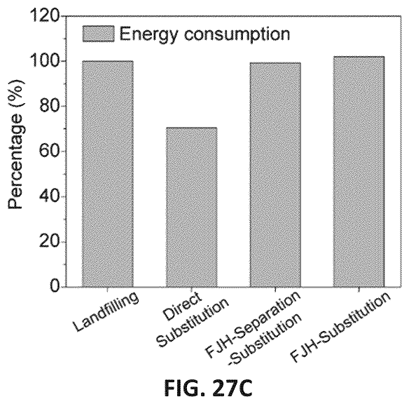

Two environmental impacts, heavy metal emissions and GHG emissions, and the energy consumption were analyzed. First, as expected, the FJH-Separation-Substitution scenario has the least heavy metal emissions (FIG. 26A and TABLE V), demonstrating ~41% reduction compared to the Landfilling scenario. See FIG. 27A.

TABLE V
Heavy Metal Emissions For Various Scenarios

| | | Direct | FJH- | FJH- |
|---|---|---|---|---|
| | Land- | Substi- | Separation- | Substi- |
| | filling | tution | Substitution | tution |
| Scenarios | (g) | (g) | (g) | (g) |
| OPC (service life) | 2.24593 | 1.572151 | 1.572151 | 2.13363 |
| CFA (service life) | 0 | 0.56364 | 0 | 0 |
| Plastic Ash (service | 0 | 0 | 0 | 0 |
| life) | | | | |
| Purified CFA (service | 0 | 0 | 0.28 | 0.0468 |
| life) | | | | |
| Mixing (CFA + OPC) | 0 | 0 | 0 | 0 |
| Mixing (CFA + Plastic | 0 | 0 | 0 | 0 |
| Ash) | | | | |
| FJH (CFA + Plastic Ash) | 0 | 0 | 0 | 0 |
| Separation (purified | 0 | 0 | 0 | 0 |
| CFA + Plastic Ash) | | | | |
| CFA (landfill) | 0.883 | 0.319 | 0 | 0.75152 |
| Plastic Ash (landfill) | 0 | 0 | 0 | 0 |
| SUM | 3.13 | 2.45 | 1.85 | 2.93 |

Note:
The materials mass flow is normalized to 1 ton of cementitious materials in service life.

The Direct Substitution scenario also exhibits a ~22% reduction in heavy metal emissions because of the lower heavy metal leakage of CFA than that of OPC. FIGS. 18D-18F. Second, for the GHG emission, the Landfilling scenario has a tremendous CO₂ emission of 854 kg per ton of the cementitious materials, the vast majority of which is from the production of OPC. FIG. 26B and TABLE VI.

TABLE VI
GHG Emissions For Various Scenarios

| | | Direct | FJH- | FJH- |
|---|---|---|---|---|
| | Land- | Substi- | Separation- | Substi- |
| | filling | tution | Substitution | tution |
| Scenarios | (kg) | (kg) | (kg) | (kg) |
| OPC (service life) | 849.4969 | 594.647 | 594.647 | 807.022 |
| CFA (service life) | 0 | 3.03 | 4.747 | 0.707 |
| Plastic Ash (service | 0 | 0 | 0.00644 | 0.00112 |
| life) | | | | |
| Purified CFA (service | 0 | 0 | 0 | 0 |
| life) | | | | |
| Mixing (CFA + OPC) | 0 | 0 | 0 | 0 |
| Mixing (CFA + Plastic | 0 | 0 | 0 | 0 |
| Ash) | | | | |
| FJH (CFA + Plastic | 0 | 0 | 0 | 0 |
| Ash) | | | | |
| Separation (purified | 0 | 0 | 0 | 0 |
| CFA + Plastic Ash) | | | | |
| CFA (landfill) | 4.747 | 1.717 | 0 | 4.04 |
| Plastic Ash (landfill) | 0.00644 | 0.00644 | 0 | 0.00532 |
| SUM | 854 | 599 | 599 | 812 |

Note:
The materials mass flow is normalized to 1 ton of cementitious materials in service life.

All other scenarios with CFA partial substitution for OPC show GHG emission reduction, i.e., ~30% for Direct Substitution, ~30% for FJH-Calcination-Substitution, and ~5% for FJH-Substitution compared to Landfilling. FIG. 27B.

Last, the Direct Substitution scenario has the least energy consumption at 3310 MJ ton⁻¹, representing ~29% reduction when compared to that of Landfilling. FIG. 26C, FIG. 27C, and TABLE VII.

TABLE VII
Energy Consumption For Various Scenarios

| | | Direct | FJH- | FJH- |
|---|---|---|---|---|
| | Land- | Substi- | Separation- | Substi- |
| | filling | tution | Substitution | tution |
| Scenarios | (MJ) | (MJ) | (MJ) | (MJ) |
| OPC (service life) | 4581 | 3207 | 3207 | 4351.95 |
| CFA (service life) | 0 | 59.7 | 93.53 | 13.93 |
| Plastic Ash (service | 0 | 0 | 1.3662 | 0.2376 |
| life) | | | | |
| Purified CFA (service | 0 | 0 | 0 | 0 |
| life) | | | | |
| Mixing (CFA + OPC) | 0 | 0 | 9.432 | 9.432 |
| Mixing (CFA + Plastic | 0 | 0 | 6.6024 | 1.0375 |
| Ash) | | | | |
| FJH (CFA + Plastic | 0 | 0 | 1340.64 | 319.176 |
| Ash) | | | | |
| Separation (purified | 0 | 0 | 1.332 | 0 |
| CFA + Plastic Ash) | | | | |
| CFA (landfill) | 102.742 | 37.162 | 0 | 87.44 |
| Plastic Ash (landfill) | 5.8742 | 5.8742 | 0 | 4.8526 |
| SUM | 4690 | 3310 | 4660 | 4788 |

Note:
The materials mass flow is normalized to 1 ton of cementitious materials in service life.

The scenarios with the FJH purification process demonstrate a slight decrease in energy consumption of ~1% for FJH-Separation-Substitution, and slight increase of ~2% for FJH-Substitution (FIG. 27C) thanks to the highly energy-efficient FJH process, as discussed above. Hence, the energy consumption of the FJH process is balanced by the reduced consumption of OPC.

Accordingly, among other advantages of the present invention, the cradle-to-gate LCA revealed that the reuse of CFA in cement could reduce heavy metal emissions by 41% and GHG emissions by 30% compared to the current waste management practice (landfilling).

### Comparison With Prior Methods

Further, a comparison was performed with the present invention and existing methods for heavy metal removal from CFA (TABLE VIII), including bioleaching [Seidel 2001], leaching using inorganic acid [Xu 2001] or organic acid [Pangayao 2014], chemical extraction by alkaline leachates [Harris 1983] or chelating agents [Harris 1983].

TABLE VIII
Comparison Of Methods For Heavy Metal Removal From CFA

| | | Materials | | | |
|---|---|---|---|---|---|
| | | Consumption | | | Removal |
| | Reaction | per ton of | Materials | Metals | efficiency |
| Method | conditions | CFA | cost | removed | (%) |
| Bioleaching | T. | Water: ~9 | Water: ~$9.8 | Al; Fe | 25; 15-22 |
| [Seidel 2001] | thiooxidans | tons | Chemicals: ~$0.06 | | |
| | bacteria; | Chemicals: ~10 | Total: ~$10 | | |
| | FAD^{a} (10% | g of H₂SO₄ | | | |
| | w/v); 3 | Others: T. | | | |
| | weeks; | thiooxidans | | | |
| | 28° C.; 200 | | | | |
| | rpm | | | | |
| Inorganic | 0.1M | Water: 80-100 | Water: | As | 83-90 |
| acid leaching | HNO₃; L/S^{b} | tons | $86.8-108.5 | | |
| [Xu 2001] | (80-100); | Chemicals: | Chemicals: | | |
| | 24° C.; 20 h | 0.50-0.63 ton | $9750-12285 | | |
| | | of HNO₃ | Total: ~$11120 | | |
| Organic acid | citric acid, | Water: 5 tons | Water: ~$5.4 | Cr | 8.6 |
| leaching | oxalic acid | Chemicals: 30 | Chemicals: ~$3472 | | |
| [Pangayao | and gluconic | kg of critic | Total: ~$3480 | | |
| 2014] | acid (0.0317 + | acid, 12 kg of | | | |
| | 0.0266 + | oxalic acid, | | | |
| | 0.0625M); | 61 kg of | | | |
| | L/S (5); | gluconic acid | | | |
| | 30° C.; 24 h; | | | | |
| | 220 rpm | | | | |
| Alkaline | NH₃ (10 | Water: 100 | Water: ~$108.5 | Mn; V; Cu; | 0; 44; 7; 5; 7 |
| leachate | mM); L/S | tons | Chemicals: ~$552 | Ni; Cr; | |
| [Harris | (100); 7 | Chemicals: 17 | Total: ~$661 | | |
| 1983] | days; pH 7.4 | kg of NH₃ | | | |
| Chelating | Histidine (10 | Water: 100 | Water: ~$108.5 | Mn; V; Cu; | 15; 31; 7; 4; |
| agent | mM); L/S | tons | Chemicals: ~$7750 | Ni; Cr | 5 |
| [Harris | (100); 7 | Chemicals: | Total: ~$7860 | | |
| 1983] | days; pH 7.4 | 155 kg of | | | |
| | | Histidine | | | |
| FJH, this | Mixing with | Water: 0 | Water: 0 | As, Cd, Co, | 91; 83; 74; |
| work | metcoke; | Chemicals: 25 | Chemicals: | Ni, Pb | 69; 72 |
| | FJH at 60-150 | kg of metcoke | $3.8 | | |
| | V; 1 s; | | Total: $3.8 | | |
| | Separation | | | | |
| | by sieving | | | | |

Note:
^{a}FAD: fly ash pulp density; ^{b}L/S: liquid/solid ratio; (c) Materials prices based upon recent information gathered: industrial water ($3.10 per 100 cubic ft, or $1.085 per ton), H₂SO₄ ($5.8 per kg), HNO₃ ($19.5 per kg), citric acid ($14.3 per kg), oxalic acid ($85.8 per kg), gluconic acid ($33 per kg), ammonium hydroxide 28-30% solution ($30.9 per gallons), Histidine ($50 per kg), and MetCoke ($150 per ton).

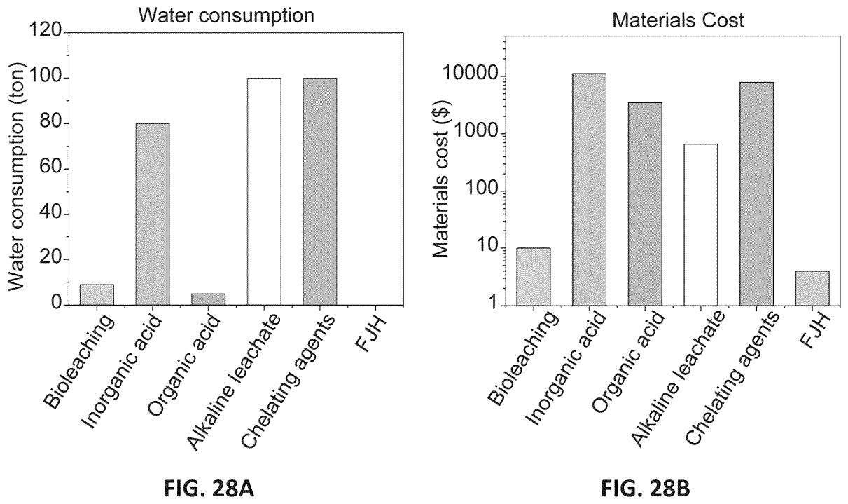

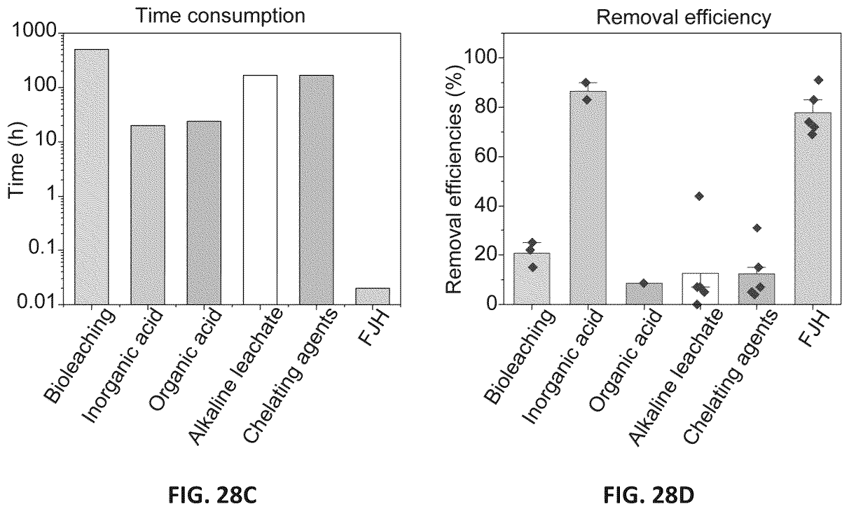

The FJH is a water-free process, while the bio- or chemical processes consumes large amounts of water. FIG. 28A. The chemical leaching methods use large amounts of chemicals such as acid, base, and chelating agents, thus the materials cost is higher than the bioleaching and FJH processes. FIG. 28B. The FJH process affords rapid treatment within seconds, much faster than the sluggish leaching processes. FIG. 28C. Lastly, the heavy metal removal efficiency of the FJH process resembles that of inorganic acid leaching efficiency, both of which are superior to other processes. FIG. 28D.

Thus, as compared to the prior art, the present invention utilizes a FJH strategy for removal of toxic heavy metals from CFA with high removal efficiencies of 70-90% by a single one-second FJH pulse. The purified CFA-derived cement was prepared and substituted to 30 wt % OPC, which showed an enhanced strength of ~51% and modulus of ~28% compared to that of pure OPC. The simulated acid rain leaching experiments show that the cement from purified CFA exhibits much less heavy metal leakage than raw CFA, and is even better than pure OPC. The cradle-to-gate LCA revealed that the reuse of CFA in cement could reduce heavy metal emissions by 41% and GHG emissions by 30% compared to the current waste management practice (landfilling). Due to the rapid treatment process and ultrafast heating and cooling rate, the FJH process is highly energy-efficient with an estimated electrical cost of ~$21 ton⁻¹ for CFA treatment. The FJH strategy is also applicable for decontaminating other wastes like BR. The ongoing commercial scale-up of the FJH process makes it further appealing in the decontamination and valorization of large-scale industrial wastes.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments±20%, in some embodiments±10%, in some embodiments ±5%, in some embodiments±1%, in some embodiments±0.5%, and in some embodiments ±0.1% from the specified amount, as such variations are appropriate to perform the disclosed method.

As used herein, the term “substantially perpendicular” and “substantially parallel” is meant to encompass variations of in some embodiments within +10° of the perpendicular and parallel directions, respectively, in some embodiments within +5° of the perpendicular and parallel directions, respectively, in some embodiments within +1° of the perpendicular and parallel directions, respectively, and in some embodiments within +0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

PCT International Patent Publication No. WO 2022/067111, entitled “Ultrafast Flash Joule Heating Methods And System For Performing Same,” to J. M. Tour, et al., filed Sep. 24, 2021 (the “Tour '111 PCT Application”).
Abrahamson, J., “Graphite sublimation temperatures, carbon arcs and crystalline erosion,” Carbon, 1974, 12, 111-141 (“Abrahamson 1974”).
Advincula, P. A., et al., “Flash graphene from rubber waste,” Carbon, 2021, 178, 649-656 (“Advincula 2021”).
Algozeeb, W. A., et al., “Flash graphene from plastic waste,” ACS Nano, 2020, 14, 15595-15604 (“Algozeeb 2020”).
Andrew, R. M., “Global CO₂ emissions from cement production, 1928-2018,” Earth Syst. Sci. Data, 2019, 11, 1675-1710 (“Andrew 2019”).
Anuar Sharuddin, S. D., et al., “A review on pyrolysis of plastic wastes,” Energy Convers. Manag., 2016, 115, 308-326 (“Anuar Sharuddin 2016”).
ASTM C618-08, “Standard Specification for Coal Fly Ash and Raw or Calcined Natural Pozzolan for Use in Concrete,” Annual Book of ASTM Standards (West Conshohocken) 2008 (“ASTM C618-08 2008”).
Barbhuiya, N. H., et al., “The Future of flash graphene for the sustainable management of solid waste,” ACS Nano, 2021, 15, 15461-15470 (“Barbhuiya 2021”).
Blissett, R. S., et al., “A review of the multi-component utilisation of coal fly ash,” Fuel, 2012, 97, 1-23 (“Blissett 2012”).
Bolan, N., et al., “Remediation of heavy metal (loid) s contaminated soils—To mobilize or to immobilize?” J. Hazard. Mater., 2014, 266, 141-166 (“Bolan 2014”).
Canpolat, F., et al., “Use of zeolite, coal bottom ash and fly ash as replacement materials in cement production,” Cem. Conc. Res., 2004, 34, 731-735 (“Canpolat 2004”).
Chancey, R. T., et al., “Comprehensive phase characterization of crystalline and amorphous phases of a Class F fly ash,” Cem. Concr. Res., 2010, 40, 146-156 (“Chancey 2010”).
Chen, W. et al., “Millisecond conversion of metastable 2D materials by flash Joule heating,” ACS Nano, 2021, 15, 1282-1290 (“Chen 2021”).
Chen, Y., et al., “Ultra-fast self-assembly and stabilization of reactive nanoparticles in reduced graphene oxide films,” Nat. Commun., 2016, 7, 12332 (“Chen I 2016”).
Chen, Y., et al., “Rapid, in situ synthesis of high capacity battery anodes through high temperature radiation-based thermal shock,” Nano Lett., 2016, 16, 5553-5558 (“Chen II 2016”).
Cheng, Y., et al., “Electric current aligning component units during graphene fiber Joule heating,” Adv. Funct. Mater., 2022, 32, 2103493 (“Cheng 2022”).
Cui, B., et al., “Waste to wealth: Defect-rich Ni-incorporated spent LiFePO4 for efficient oxygen evolution reaction,” Sci. China Mater., 2021, 64, 2710-2718 (“Cui 2021”).
Dachn, K., et al., “Innovations to decarbonize materials industries,” Nat. Rev. Mater., 2002, 7, 275-294 (“Daehn 2022”).
Deady, E. A., et al., “A review of the potential for rare-earth element resources from European red muds: examples from Seydisehir, Turkey and Parnassus-Giona, Greece,” Mineral. Mag., 2016, 80, 43-61 (“Deady 2016”).
Deng, B., et al., “Phase controlled synthesis of transition metal carbide nanocrystals by ultrafast flash Joule heating,” Nat. Commun., 2022, 13, 262 (“Deng I 2022”).
Deng, B., et al., “Rare earth elements from waste,” Sci. Adv., 2022, 8, eabm3132 (“Deng II 2022”).
Deng, B., et al., “Urban mining by flash Joule heating,” Nat. Commun., 2021, 12, 5794 (“Deng 2021”).
Environmental Protection Agency, “Hazardous and Solid Waste Management System; Disposal of Coal Combustion Residuals From Electric Utilities; Final Rule,” Federal Register, Vol. 80, No. 74 (Apr. 17, 2015): 21301 (“EPA 2015”).
Environmental Protection Agency, “Method 3050B: Acid Digestion of Sediments, Sludges, and Soils,” Revision 2, Washington, D C, 1996 (“EPA 1996”).
Fernández-Turiel, J. L., et al., “Mobility of heavy metals from coal fly ash,” Environ. Geol., 1994, 23, 264-270 (“Fernández-Turiel 1994”).
Harris, W. R., et al., “Time-dependent leaching of coal fly ash by chelating agent,” Environ. Sci. Technol., 1983, 17, 139-145 (“Harris 1983”).
Ishaq, M., et al., L″eaching capabilities of iodine monochloride (ICI) and diethylenetriamine pentaacetic acid (DPTA) at different concentrations and pH for some major and trace metals from coal and coal fly ash,” Arabian J. Geosci., 2013, 6, 4109-4118 (“Ishaq 2013”).
ISO 14044:2006, “Environmental Management—Life Cycle Assessment—Requirements and Guidelines, 2006 (“ISO 14044”).
Jiang, R., et al., “Ultrafast synthesis for functional nanomaterials,” Cell Rep. Phys. Sci., 2021, 2, 100302 (“Jiang 2021”).
Kashiwakura, S., et al., “Removal of arsenic in coal fly ash by acid washing process using dilute H₂SO₄ solvent,” J. Hazard. Mater., 2010, 181, 419-425 (“Kashiwakura 2010”).
Koukouzas, N., et al., “Heavy metal characterization of CFB-derived coal fly ash,” Fuel Process. Technol., 2011, 92, 441-446 (“Koukouzas 2011”).
Lide, D. R., CRC Handbook of Chemistry and Physics (CRC Press) 2005 (“Lide 2005”).
Liu, C., et al., “Air-assisted transient synthesis of metastable nickel oxide boosting alkaline fuel oxidation reaction,” Adv. Funct. Mater., 2020, 10, 2001397-2001404 (“Liu C 2020”).
Liu, P., et al., “Speciation, distribution, and mobility of hazardous trace elements in coal fly ash: Insights from Cr, Ni, and Cu,” Energy Fuels, 2020, 34, 14333-14343 (“Liu P 2020”).
Liu, P., et al., “Comprehensive understandings of rare earth element (REE) speciation in coal fly ashes and implication for REE extractability,” Environ. Sci. Technol., 2019, 53, 5369-5377 (“Liu P 2019”).
Liu, S., et al., “Extreme environmental thermal shock induced dislocation-rich Pt nanoparticles boosting hydrogen evolution reaction,” Adv. Mater., 2022. 34, 2106973-2106979 (“Liu S 2022”).
Liu, S., et al., “Dislocation-strained IrNi alloy nanoparticles driven by thermal shock for the hydrogen evolution reaction,” Adv. Mater., 2020, 32, 2006034-2006041 (“Liu S 2020”).
Lu, J., et al., “Millisecond conversion of photovoltaic silicon waste to binder-free high silicon content nanowires electrodes,” Adv. Energy Mater., 2021, 11, 2102103 (“Lu 2021”).
Luong, D. X., et al., “Gram-scale bottom-up flash graphene synthesis,” Nature, 2020, 577, 647-651 (“Luong 2020”).
Ma, W., et al., “Performance of chemical chelating agent stabilization and cement solidification on heavy metals in MSWI fly ash: A comparative study,” J. Environ. Manage., 2019, 247, 169-177 (“Ma 2019”).
Meer, I., et al . . . “Removal techniques for heavy metals from fly ash,” J. Mater. Cycles Waste Manag., 2018, 20, 703-722 (“Meer 2018”).
Menya, E., et al., “Optimization of pyrolysis conditions for char production from rice husks and its characterization as a precursor for production of activated carbon,” Biomass Convers. Biorefin., 2020, 10, 57-72 (“Menya 2020”).
Miller, S. A., et al., “Environmental impacts of alternative cement binders,” Environ. Sci. Technol. 2020, 54, 677-686 (“Miller 2020”).
Nabavi-Pelesaraei, A., et al., “Modeling of energy consumption and environmental life cycle assessment for incineration and landfill systems of municipal solid waste management-A case study in Tehran Metropolis of Iran” J. Clean. Prod., 2017, 148, 427-440 (“Nabavi-Pelesaraei 2017”).
OchsenkuhnPetropulu, M., et al., “Recovery of lanthanides and yttrium from red mud by selective leaching,” Anal. Chim. Acta, 1996, 319, 249-254 (“OchsenkuhnPetropulu 1996”).
Olivier, J. G. J., et al., “Trends in global CO₂ emissions: 2016 report,” PBL Netherlands Environmental Assessment Agency, 2016 (“Olivier 2016”).
Pangayao D, et al., “Leaching of chromium from coal ash using citric acid, oxalic acid and gluconic acid by batch leaching procedure,” In: IEEE 2014 International Conference on Humanoid, Nanotechnology, Information Technology, Communication and Control, Environment and Management (HNICEM), 2014 (“Pangayao 2014”).
Praharaj, T., et al., “Leachability of elements from sub-bituminous coal fly ash from India,” Environ. Int., 2002, 27, 609-615 (“Praharaj 2002”).
Rafieizonooz, M., et al., “Investigation of coal bottom ash and fly ash in concrete as replacement for sand and cement,” Constr. Build. Mater., 2016, 116, 15-24 (“Rafieizonooz 2016”).
Rivera, N., et al., “Chemical speciation of potentially toxic trace metals in coal fly ash associated with the Kingston fly ash spill,” Energy Fuels, 2017, 31, 9652-9659 (“Rivera 2017”).
Sahoo, P. K., et al., “Recovery of metals and other beneficial products from coal fly ash: a sustainable approach for fly ash management,” Int. J Coal Sci. Technol., 2016, 3, 267-283 (“Sahoo 2016”).
Seidel, A., et al., “Mechanism of bioleaching of coal fly ash by Thiobacillus thiooxidans,” Chem. Eng. J., 2001, 83, 123-130 (“Seidel 2001”).
Service, R. F., “Red alert,” Science, 2020, 369, 910-911 (“Service 2020”).
Stanford, M. G., et al., “Flash Graphene Morphologies,” ACS Nano, 2020, 14, 13691-13699 (“Stanford 2020”).
Teixeira, E. R., et al., “Comparative environmental life-cycle analysis of concretes using biomass and coal fly ashes as partial cement replacement material,” J. Clean. Prod., 2016, 112, 2221-2230 (“Teixeira 2016”).
Thomas, M., “Optimizing the use of fly ash in concrete,” Portland Cement Association, 2007 (“Thomas 2007”).
Wang, C. W., et al., “A general method to synthesize and sinter bulk ceramics in seconds,” Science, 2020, 368, 521-526 (“Wang C 2020”).
Wang, N. N., et al., “Leachability and adverse effects of coal fly ash: A review,” J. Hazard. Mater., 2020, 396, 122725 (“Wang N 2020”).
Wyss, K. M., et al., “Converting plastic waste pyrolysis ash into flash graphene,” Carbon, 2021, 174, 430-438 (“Wyss 2021”).
Xu, Y. H., et al., “Leaching of arsenic from coal fly ashes 1. leaching behavior of arsenic and mechanism study,” Toxicol. Environ. Chem., 2001, 81, 55-68 (“Xu 2001”).
Yao, Y., et al., “High temperature shockwave stabilized single atoms,” Nat. Nanotechnol., 2019, 14, 851-857 (“Yao 2019”).
Yao, Y., et al., “Carbothermal shock synthesis of high-entropy-alloy nanoparticles,” Science, 2018, 359, 1489-1494 (“Yao 2018”).
Yao, Z. T., et al., “A comprehensive review on the applications of coal fly ash,” Earth-Sci. Rev., 2015, 141, 105-121 (“Yao 2015”).
Yao, Z. T., et al., “A review of the alumina recovery from coal fly ash, with a focus in China,” Fuel, 2014, 120, 74-85 (“Yao 2014”).
Yu, Q., et al., “The leachability of heavy metals in hardened fly ash cement and cement-solidified fly ash,” Cem. Concr. Res., 2005, 35, 1056-1063 (“Yu 2005”).
Zhang, W. C., et al., “Comprehensive review of rare earth elements recovery from coal-related materials,” Minerals, 2020, 10, 451-478 (“Zhang 2020”).
Zhong, X. Y., et al., “Global greenhouse gas emissions from residential and commercial building materials and mitigation strategies to 2060,” Nat. Commun., 2021, 12, 6126 (“Zhong 2021”).

1. A method of forming a cementitious material, wherein the method comprises:
(a) forming a mixture comprising post-industrial waste and a conductive additive;
(b) applying a voltage across the mixture, wherein
(i) the voltage is applied in one or more voltage pulses,
(ii) duration of each of the one or more voltage pulses is for a duration period, and
(iii) the applying of the voltage removes at least 50% by weight of the heavy metals from the post-industrial waste to form a purified post-industrial waste;
(c) mixing the purified post-industrial waste with cement to form a cementitious material.

2. The method of claim 1, wherein the post-industrial waste is fly ash.

3-5. (canceled)

6. The method of claim 1, wherein the post-industrial waste is bauxite residue.

7. The method of claim 1, wherein the post-industrial waste is slag.

8. (canceled)

9. The method of claim 1, wherein the post-industrial waste is mining tailings.

10. The method of claim 1, wherein the post-industrial waste is silica fume.

11. (canceled)

12. The method of claim 1, wherein the conductive additive is a carbon source.

13-16. (canceled)

17. The method of claim 1, wherein the conductive source comprises metal flakes.

18-23. (canceled)

24. The method of claim 1, wherein the applying of the voltage removes at least 70% by weight of the heavy metals from the post-industrial waste to form a purified post-industrial waste.

25-26. (canceled)

27. The method of claim 1, wherein the heavy metals comprise one or more metals selected from the group consisting of Al, As, Ba, Be, Bi, B, Ca, Cd, Cs, Cr, Co, Cu, Ga, In, Fe, Pb, Li, Mg, Mn, Ni, P, K, Rb, Se, Si, Ag, Na, Sr, S, Te, TI, V, Zn, and combinations thereof.

28. (canceled)

29. The method of claim 1 further comprising removing residual carbon from the post-industrial waste after the step of applying the voltage across the mixture.

30. The method of claim 29, wherein the step of removing the residual carbon comprises calcination.

31-32. (canceled)

33. The method of claim 29, wherein the step of removing the residual carbon comprises a physical separation step.

34. (canceled)

35. The method of claim 1, wherein the purified post-industrial waste is mixed with the cement in a weight ratio between about 1:9 and about 1:1.

36. (canceled)

38. The method of claim 1, wherein the method is a water-free process.

39. The method of claim 1, wherein the method does not comprise an acid wash step.

40-58. (canceled)

59. A system for forming a cementitious material, wherein the system comprises:
(a) a source of a mixture comprising post-industrial waste and a conductive additive;
(b) a cell operably connected to the source such that the mixture can be flowed into the cell and held under compression;
(c) electrodes operatively connected to pressure cell;
(d) a flash power supply for applying a voltage across the mixture, wherein
(i) the voltage is applied in one or more voltage pulses,
(ii) duration of each of the one or more voltage pulses is for a duration period, and
(iii) the applying of the voltage removes at least 50% by weight of the heavy metals from the post-industrial waste to form a purified post-industrial waste;
(e) a collector operatively connected to the cell to collect the purified post-industrial waste; and
(f) a mixer operable for mixing the collected purified post-industrial waste with cement to form the cementitious material.

60. (canceled)

61. The system of claim 59, wherein the method for making the cementitious material is a water-free process.

62. The system of claim 59, wherein the method for making the cementitious material does not comprise an acid wash step.

63. (canceled)

64. The system of claim 59, wherein the post-industrial waste is fly ash.

65-67. (canceled)

68. The system of claim 59, wherein the post-industrial waste is bauxite residue.

69. The system of claim 59, wherein the post-industrial waste is slag.

70. (canceled)

71. The system of claim 59, wherein the post-industrial waste is mining tailings.

72. The system of claim 59, wherein the post-industrial waste is silica fume.

73. (canceled)

74. The system of claim 59, wherein the conductive additive is a carbon source.

75-78. (canceled)

79. The system of claim 59, wherein the conductive source comprises metal flakes.

80-85. (canceled)

86. The system of claim 59, wherein the applying of the voltage removes at least 70% by weight of the heavy metals from the post-industrial waste to form a purified post-industrial waste.

87. (canceled)

88. The system of claim 59, wherein the heavy metals comprise one or more metals selected from the group consisting of Al, As, Ba, Be, Bi, B, Ca, Cd, Cs, Cr, Co, Cu, Ga, In, Fe, Pb, Li, Mg, Mn, Ni, P, K, Rb, Se, Si, Ag, Na, Sr, S, Te, TI, V, Zn, and combinations thereof.

89-90. (canceled)

91. The system of claim 59, wherein the system further comprises a separator for removing residual carbon from the post-industrial waste after the step of applying the voltage across the mixture.

92. The system of claim 91, wherein the separator comprises a calciner for calcination of the post-industrial waste after the step of applying the voltage across the mixture.

93-94. (canceled)

95. The system of claim 91, wherein the separator is a physical separator.

96. (canceled)

97. The system of claim 59, wherein the cementitious cement comprises the purified post-industrial waste and the cement in a weight ratio between about 1:9 and about 1:1.

98-99. (canceled)
